(19) United States
(12) Patent Application Publication
(10) Pub. No.: US 2005/0008974 A1
(43) Pub. Date: Jan. 13, 2005

(54) Writable high-capacity optical storage media containing metal complexes

(76) Inventors: Colin Morton, Basel (CH); Taher Yousaf, Basel (CH); Jean-Luc Budry, Rossemaison (CH); Beat Schmidhalter, Bubendorf (CH); Heinz Spahni, Frenkendorf (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/495,678

(22) PCT Filed: Nov. 7, 2002
(86) PCT No.: PCT/EP02/12425

(51) Int. Cl. G11B 7/24; C09B 47/04

(52) U.S. Cl. 430/270.16; 430/270.17; 540/128; 540/135

(57) ABSTRACT

The invention relates to an optical recording medium comprising a substrate and a recording layer, wherein the recording layer comprises a complex of formula (I), or wherein Q² is a ligand of formula (II), or a tautomer thereof, and R₁, R₂, R₃, R₄, R₅, R₆, R₇, and R₈ are each dependently of the others H, halogen, cyano, COOR₉, CONHR₉, CONR₉R₁₀, R₉, OR₉, SR₉, NHR₉ or NR₉R₁₀, wherein R₉ and R₁₀ are each independently of the other C₆-C₁₀aryl, C₄-C₉heteroaryl or linear or branched C₁-C₂₄alkyl, C₃-C₂₄cycloallyl, C₂-C₂₄alkenyl, C₃-C₂₄cycloalkenyl, C₂-C₂₄alkynyl, C₁-C₁₂heterocycloalkyl, C₁-C₁₂heterocycloalkenyl, unsubstituted or substituted, it also being possible for R₁ and R₂, R₃ and R₄, R₅ and R₆, and R₇ and R₈, independently of one another, to be bonded by a direct bond or via a bridge O or S, M^{m+} is a transition metal cation having 5 or 6 electrons in the outermost occupied d-shell, L₁ is a ligand having a sub-structure N—C, P—C or As—C, L₂, independently of L₁, is a further ligand containing at least one hetero atom N, P, As, O, S, Se or Te, L₃⁻ is CN⁻, SCN⁻, NCS⁻, OCN⁻, NCO⁻, N₃—, L₁-O⁻, L₁-S—, L₁-CO₂⁻, L₁-S0₃⁻ or L₁-P0₃⁻, L₄⁻, independently of L₃⁻, is CN⁻, SCN⁻, NCS⁻, OCN⁻, NCO⁻, N₃⁻, L₃-O⁻, L₃-S⁻, L₃-CO₂^{- L}₃-SO₃⁻ or L₃-PO₃⁻, p and q are each independently of the other a number 0 or 1 (formula III), are each a counter-ion, m is a number 1, 2, 3 or 4 equal to the positive charge in M^{m+} and n is a number −2, −1, +1 or +2, so that the quotient (formula IV) is not negative. Amorphous solid layers having excellent optical properties are obtained.

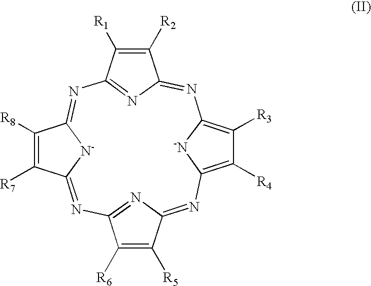

The field of the invention is the optical storage of information on write-once storage media, the information marks being differentiated by the different optical properties of a colorant at written and unwritten sites. This technology is usually termed “WORM” (for example “CD-R” or “DVD-R”); those terms have been retained herein.

Compact discs that are writable at a wavelength of from 770 to 830 nm are known from “Optical Data Storage 1989”, Technical Digest Series Vol. 1, 45 (1989); many different variants thereof are commercially available. By the use of more recent compact high-performance red diode lasers that emit in the range of from 600 to 700 nm, however, it is possible in principle to achieve a 5- to 8-fold improvement in data packing density, in that the track pitch (distance between two turns of the information track) and the size of the bits can be reduced to approximately half the value in comparison with conventional CDs.

This highly desirable evolution from CD-R to DVD-R and further to optical media compatible with a blue laser imposes extraordinarily high demands on the recording layer to be used, however, such as high refractive index, uniformity of script width at different length pulse durations and also high light stability in daylight with, at the same time, high sensitivity to high-energy laser radiation. The known recording layers do not possess those properties to an entirely satisfactory extent.

Octaphenyl-porphyrazines and the similarity of their chemical properties to phthalo-cyanines, except for their appreciable solubility in cold organic solvents, have been disclosed by A. H. Cook and R. P. Linstead (J. Chem. Soc. 1937, 929-933).

U.S. Pat. No. 5,998,093 proposes the use of porphyrazines in optical recording media. It is necessary, however, for at least one of the peripheral radicals to be halogen, cyano or unsubstituted, or substituted alkoxy. In addition, excellent recording and playback properties are obtained only with Pd, Ni, Co, Pt, Cu, Zn or V(═O) on account of their lower decomposition temperature. Some of the structures indicated are coated onto a grooved polycarbonate disc from a solution of methylcyclohexane, 2-methoxy-ethanol, ethyl methyl ketone and tetrahydrofuran, but no amounts are given, and written using a laser of 635 nm, including

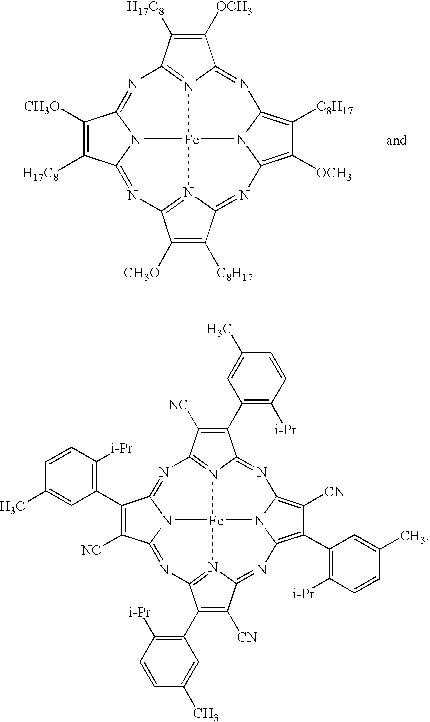

Comparison Examples A-1 to A-3 of WO 01/47719 disclose tetra-tert-butyl-tetraaza-palladium(II) porphyrin and the use thereof in optical storage media. Pd(II) is a transition metal cation having 8 electrons in the outermost occupied d-shell (d⁸).

JP-A-2001/287460 discloses the use of diaza-porphyrins having axially coordinated N-containing aromatic heterocycles in optical storage media. No synthetic examples enabling the preparation of compounds in satisfactory purity are given. Pits can be written and read out with a C/N ratio of ≧40 db, but the properties in practical use for optical recording (for example jitter or PI sum 8) are still not entirely satisfactory.

EP-1 189 218 and JP-A-2002/192834 are earlier patent applications which were published only after the priority date of the present invention.

It has been shown, however, that especially the properties of known compounds in solid form leave something to be desired, for example cold solubility, crystallisation tendency and the height and gradient of the absorption bands.

The aim of the invention is to provide an optical recording medium, the recording layer of which has high storage capacity combined with excellent other properties. The recording medium should be both writable and readable at high speed, with a minimum of errors, at the same wavelength in the range of from 300 to 700 nm (preferably from 350 to 500 nm or from 600 to 700 nm, especially from 350 to 450 nm or from 630 to 690 nm).

Very surprisingly, by the use of certain porphyrazines as recording layer it has been possible to provide an optical recording medium having properties that are astonishingly better than those of recording media known hitherto.

The invention accordingly relates to an optical recording medium comprising a substrate and a recording layer, wherein the recording layer comprises a complex of formula

$$\begin{matrix}\{ [ {Q}^{2 -} ] \cdot [ {M}^{m +} ] \cdot [ {L}_{1} ] {( \cdot [ {L}_{2} ] )}_{p} \} {X}_{\frac{2 - m}{n}}^{n} , & ( Ia ) \\ \{ [ {Q}^{2 -} ] \cdot [ {M}^{m +} ] \cdot [ {L}_{3}^{-} ] {( \cdot [ {L}_{2} ] )}_{p} \} {X}_{\frac{3 - m}{n}}^{n} or & ( Ib ) \\ \{ [ {Q}^{2 -} ] \cdot [ {M}^{m +} ] \cdot [ {L}_{3}^{-} ] \cdot [ {L}_{4}^{-} ] \} {X}_{\frac{4 - m}{n}}^{n} , & ( Ic )\end{matrix}$$

wherein
Q²⁻ is a ligand of formula 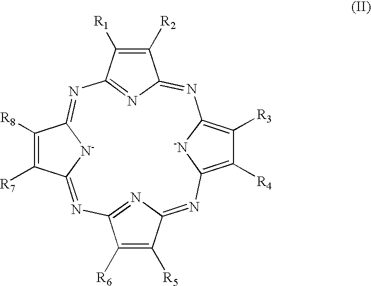
   or a tautomer thereof,
and R₁, R₂, R₃, R₄, R₅, R₆, R₇ and R₈ are each independently of the others H, halogen, cyano, COOR₉, CONHR₉, CONR₉R₁₀, R₉, OR₉, SR₉, NHR₉ or NR₉R₁₀ wherein R₉ and R₁₀ are each independently of the other C₆-C₁₀aryl, C₄-C₉heteroaryl or linear or branched C₁-C₂₄alkyl, C₃-C₂₄cycloalkyl, C₂-C₂₄alkenyl, C₃-C₂₄cycloalkenyl, C₂-C₂₄alkynyl, C₁-C₁₂heterocycloalkyl, C₁-C₁₂heterocycloalkenyl, C₇-C₂₄aralkenyl or C₇-C₂₄aralkyl, each of which may be unsubstituted or substituted, it also being possible for R₁ and R₂, R₃ and R₄, R₅ and R₆, and R₇ and R₈, independently of one another, to be bonded by a direct bond or via a bridge O or S,
M^{m+} is a transition metal cation having 5 or 6 electrons in the outermost occupied d-shell,
L₁ is a ligand having a sub-structure N—C, P—C or As—C,
L₂, independently of L₁, is a further ligand containing at least one hetero atom N, P, As, O, S, Se or Te,
L₃⁻ is CN⁻, SCN⁻, NCS⁻, OCN⁻, NCO⁻, N₃⁻, L₁-O⁻, L₁-S⁻, L₁-CO₂⁻, L₁-SO₃⁻ or L₁-PO₃⁻,
L₄⁻, independently of L₃⁻, is CN⁻, SCN⁻, NCS⁻, OCN⁻, NCO⁻, N₃⁻, L₃-O⁻, -L₃-S⁻, L₃-CO₂⁻, L₃-SO₃⁻ or L₃-PO₃⁻,
p and q are each independently of the other a number 0 or 1,

$${X}_{\frac{2 - m}{n}}^{n} , {X}_{\frac{3 - m}{n}}^{n} and {X}_{\frac{4 - m}{n}}^{n}$$

are each a counter-ion, m is a number 1, 2, 3 or 4 equal to the positive charge in M^{m+} and n is a number −2, −1, +1 or +2, so that the quotient

$$\frac{2 - m}{n} , \frac{3 - m}{n} or \frac{4 - m}{n}$$

is not negative.

The substituents of R₉ and R₁₀ may be any desired substituents, for example halogen, hydroxy, C₁-C₁₂alkyl, C₁-C₁₂alkoxy, C₁-C₈alkylthio, cyano, COOR₁₁ or P(O)OR₁₁R,₁₂, wherein R₁₁ and R₁₂ are each independently of the other linear or branched C₁-C₂₄alkyl, C₃-C₁₂cycloalkyl, C₇-C₂₄aralkyl, C₆-C₁₀aryl or C₄-C₉heteroaryl. Those substituents may themselves also be substituted, for example by halogen, hydroxy, formyl, C₁-C₁₂alkoxy, C₁-C₁₂alkoxycarbonyl, C₁-C₁₂alkylamino-or di(C₁-C₁₂alkyl)amino. All substituents disclosed elsewhere in this specification also come into consideration as R₉ or R₁₀.

The complexes of formulae (Ia), (Ib) and (Ic) are coordination metal complexes.

Transition metal cations having 5 or 6 electrons in the outermost occupied d-shell are often referred to in textbooks also as “d⁵” or “d⁶” cations and are, for example, Mn⁺, Mn²⁺, Fe²⁺, Fe³⁺, Co³⁺, Co⁴⁺, Ru²⁺, Ru³⁺, Os²⁺, Os³⁺ and Rh⁴⁺. Preference is given to transition metal cations having 6 electrons in the outermost occupied d-shell (“d⁶”), especially Fe²⁺ or Co³⁺ more especially Fe²⁺.

Alkyl, alkenyl or alkynyl may be straight-chain or branched. Alkenyl is alkyl that is mono- or poly-unsaturated, wherein two or more double bonds may be isolated or conjugated. Alkynyl is alkyl or alkenyl that is doubly-unsaturated one or more times, wherein the triple bonds may be isolated or conjugated with one another or with double bonds. Cycloalkyl or cycloalkenyl is monocyclic or polycyclic alkyl or alkenyl, respectively.

C₁-C₂₄Alkyl can therefore be, for example, methyl, ethyl, n-propyl, isopropyl, n-butyl, sec-butyl, isobutyl, tert-butyl, 2-methyl-butyl, n-pentyl, 2-pentyl, 3-pentyl, 2,2-dimethylpropyl, n-hexyl, heptyl, n-octyl, 1,1,3,3-tetramethylbutyl, 2-ethylhexyl, nonyl, decyl, undecyl, dodecyl, tridecyl, tetradecyl, pentadecyl, hexadecyl, heptadecyl, octadecyl, nonadecyl, eicosyl, heneicosyl, docosyl or tetracosyl.

C₃-C₂₄Cycloalkyl can therefore be, for example, cyclopropyl, cyclopropyl-methyl, cyclobutyl, cyclopentyl, cyclohexyl, cyclohexyl-methyl, trimethylcyclohexyl, thujyl, norbornyl, bornyl, norcaryl, caryl, menthyl, norpinyl, pinyl, 1-adamantyl, 2-adamantyl, 5α-gonyl, 5ξ-pregnyl, (+) 1,3,3-trimethylbicyclo[2.2.1]heptyl (fenchyl) or, where applicable, the optical antipodes thereof.

C₂-C₂₄Alkenyl is, for example, vinyl, allyl, 2-propen-2-yl, 2-buten-1-yl, 3-buten-1-yl, 1,3-butadien-2-yl, 2-penten-1-yl, 3-penten-2-yl, 2-methyl-i -buten-3-yl, 2-methyl-3-buten-2-yl, 3-methyl-2-buten-1-yl, 1,4-pentadien-3-yl, or any desired isomer of hexenyl, octenyl, nonenyl, decenyl, dodecenyl, tetradecenyl, hexadecenyl, octadecenyl, eicosenyl, heneicosenyl, docosenyl, tetracosenyl, hexadienyl, octadienyl, nonadienyl, decadienyl, dodecadienyl, tetradecadienyl, hexadecadienyl, octadecadienyl or eicosadienyl.

C₃-C₂₄Cycloalkenyl is, for example, 2-cyclobuten-1-yl, 2-cyclopenten-1-yl, 2-cyclohexen-1-yl, 3-cyclohexen-1-yl, 2,4-cyclohexadien-1-yl, 1-p-menthen-8-yl, 4(10)-thujen-10-yl, 2-norbornen-1-yl, 2,5-norbornadien-1 -yl, 7,7-dimethyl-2,4-norcaradien-3-yl or camphenyl.

C₁-C₂₄Alkoxy is O—C₁-C₂₄alkyl, and C₁-C₂₄alkylthio is S—C₁-C₂₄alkyl.

C₂-C₂₄Alkynyl is, for example, 1-propyn-3-yl, 1-butyn-4-yl, 1-pentyn-5-yl, 2-methyl-3-butyn-2-yl, 1,4-pentadiyn-3-yl, 1,3-pentadiyn-5-yl, 1-hexyn-6-yl, cis-3-methyl-2-penten-4-yn-1-yl, trans-3-methyl-2-penten4-yn-1-yl, 1,3-hexadiyn-5-yl, 1-octyn-8-yl, 1-nonyn-9-yl, 1-decyn-10-yl or 1-tetracosyn-24-yl.

C₇-C₂₄Aralkyl is, for example, benzyl, 2-benzyl-2-propyl, β-phenyl-ethyl, 9-fluorenyl, α,α-dimethylbenzyl, ω-phenyl-butyl, ω-phenyl-octyl, ω-phenyl-dodecyl or 3-methyl-5-(1′,1′,3′,3′-tetramethyl-butyl)-benzyl. C₇-C₂₄Aralkyl can also be, for example, 2,4,6-tri-tert-butyl-benzyl or 1-(3,5-dibenzyl-phenyl)-3-methyl-2-propyl. When C₇-C₂₄aralkyl is substituted, either the alkyl moiety or the aryl moiety of the aralkyl group can be substituted, the latter alternative being preferred.

C₆-C₂₄Aryl is, for example, phenyl, naphthyl, biphenylyl, 2-fluorenyl, phenanthryl, anthracenyl or terphenylyl.

Furthermore, aryl and aralkyl can also be aromatic groups bonded to a metal, for example in the form of metallocenes of transition metals known per se, more especially 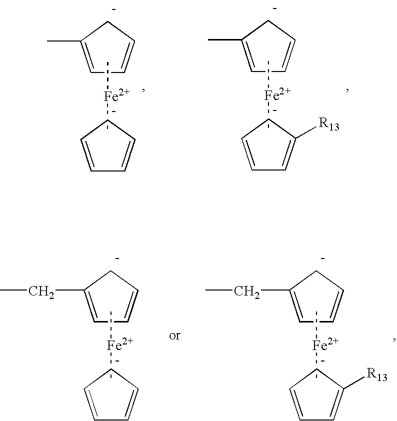
wherein R₁₃ is CH₂OH, CH₂OR₁₁, COOH, COOR₁₁ or COO⁻.

C₄-C₁₂Heteroaryl is an unsaturated or aromatic radical having 4n+2 conjugated π-electrons, for example 2-thienyl, 2-furyl, 1-pyrazolyl, 2-pyridyl, 2-thiazolyl, 2-oxazolyl, 2-imidazolyl, isothiazolyl, triazolyl or any other ring system consisting of thiophene, furan, pyridine, thiazole, oxazole, imidazole, isothiazole, thiadiazole, triazole, pyridine and benzene rings and unsubstituted or substituted by from 1 to 6 ethyl, methyl, ethylene and/or methylene substituents.

C₁-C₁₂Heterocycloalkyl or C₁-C₁₂heterocycloalkenyl is an unsaturated or partially unsaturated ring system radical, for example tetrazolyl, pyrrolidyl, piperidyl, piperazinyl, imidazolinyl, pyrazolidinyl, pyrazolinyl, morpholinyl, quinuclidinyl or another C₄-C₁₂heteroaryl that is mono- or poly-hydrogenated.

Halogen is chlorine, bromine, fluorine or iodine, preferably chlorine or bromine.

R, to R₇ are preferably phenyl or naphthyl, especially phenyl. R₈ is preferably also phenyl or naphthyl, especially phenyl. R₁ to R₈ are preferably unsubstituted or substituted from 1 to 3 times by halogen, hydroxy, nitro, Z₁, OZ₁, SZ₁, NHZ₁, NZ₁Z₂, CHO, CHOZ₁OZ₂, CHNZ₁, CO₂H, CO₂Z₁, CONHZ₁, CONZ₁Z₂, SO₂Z₁, SO₂NHZ₁, SO₂NZ₁Z₂, SO₃Z₁, P(O)OZ₁OZ₂, O—P(O)OZ₁OZ₂, C₁-C₆alkylene-OH or C₁-C₈alkylene-OZ, wherein Z₁ and Z₂ are each independently of the other C₁-C₂₄alkyl uninterrupted or interrupted by from 1 to 3 oxygen and/or silicon atoms, Z₁ and Z₂ being unsubstituted or partially fluorinated or perfluorinated or substituted by one or two hydroxy substituents or by a metallocenyl radical. Z₁ and Z₂ are especially C₁-C₈alkyl, CH₂-CH₂—OH, —CH₂—O—CH₃, —CH₂—O—(CH₂)₇—CH₃, —CH₂—CH₂—O—CH₂—CH₃, —CH₂—CH(OCH₃)₂, —CH₂—CH₂—CH(OCH₃)₂, —CH₂—C(OCH₃)₂—CH₃, —CH₂—CH₂—O—CH₂—CH₂—O—CH₃, —(CH₂)₃13 OH, —(CH₂)₆—OH, —(CH₂)₇—OH, —(CH₂)₈—OH, —(CH₂)₉—OH, —(C H₂)₁₀—OH, —(CH₂)₁₁—OH, —(CH₂)₁₂—OH, —CH₂—Si(CH₃)₃, —CH₂—CH₂—O—Si(CH₃)₂—C(CH₃)₃, —(CH₂)₃—O—Si(CH₃)₂—C(CH₃)₃, —(CH₂)₄—O—Si(C₆H₅)₂—C(CH₃)₃, —(CH₂)₃—O—Si(CH(CH₃)₂)₃, —CH₂—CH₂—CH(CH₃)—CH₂—CH₂—CH(OH)—C(CH₃)_{2—OH, —CH}₂—CH(CH₃)—CH₂—OH, —CH₂—C(CH₃)₂—CH₂—OH, —CH₂—C(CH₂—OH)₃, —CH₂—CH(OH)—CH₃, 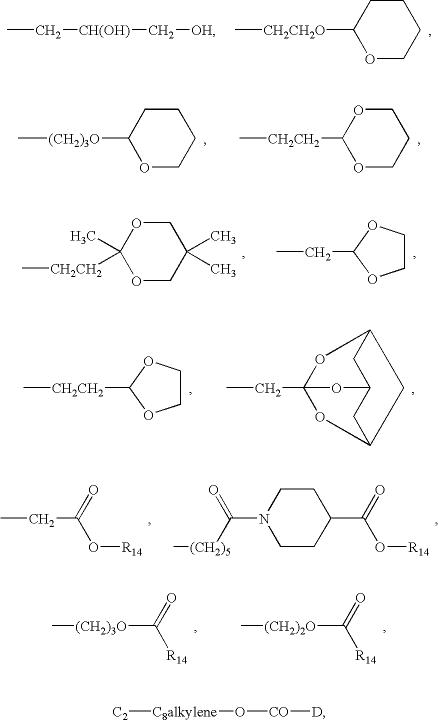
C₂-C₈alkylene-COO-D or C₂-C₈alkylene-N═CH-D), wherein D is 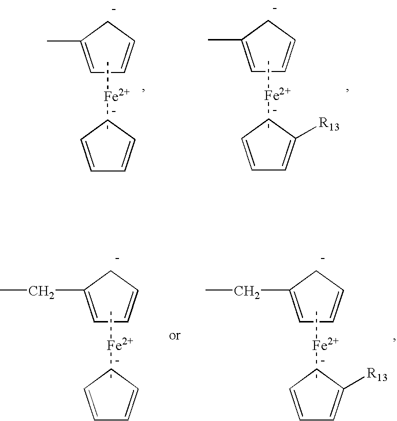
R₁₃ is CH₂OH, CH₂OR₁₁, COOH, COOR₁₁ or COO⁻, and R₁₄ is C₁-C₂₄alkyl, C₂-C₂₄alkenyl or C₂-C₂₄alkynyl, each of which is uninterrupted or interrupted by from 1 to 3 oxygen and/or silicon atoms, or is C₃-C₂₄cycloalkyl, C₃-C₂₄cycloalkenyl, C₇-C₂₄aralkyl, C₆-C₂₄aryl, C₄-C₁₂heteroaryl or C₁-C₁₂heterocycloalkyl.

Metallocenyl radicals preferably contain as metal Ni, Co, Cu or especially Fe.

Examples of R₁₄ as C₆-C₂₄aryl are metallocenyl radicals of formulae

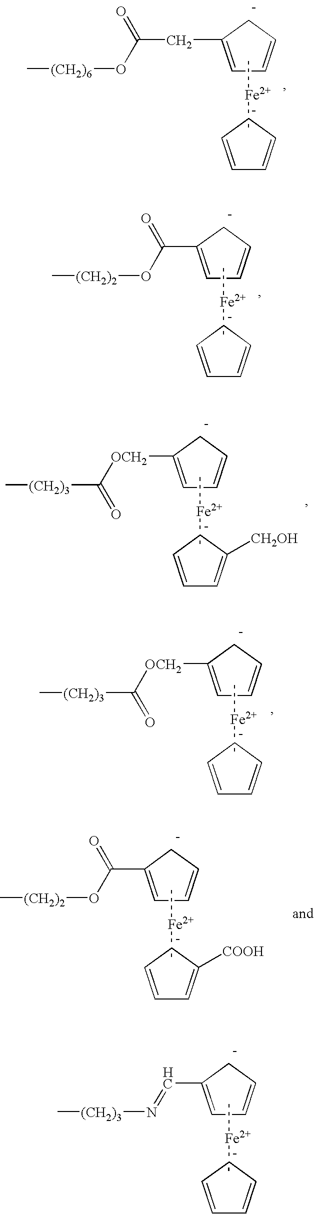

The geometry of the ligands Q²⁻, L₁, L₃⁻ and, where applicable, L₂ and L₄⁻ around the metal M^{m+} is not relevant per se, since the formation of a uniform crystal lattice is undesirable. For the coating of optical recording media, the complexes of (Ia), (Ib) or (Ic) are preferably obtained rather in amorphous form, the structure of which cannot be investigated. It is assumed that on rapid vaporisation of the solvent all possible position isomers are frozen next to one another in the solid, it being possible for L₁, L₃⁻ and, where applicable, L₂ and L₄⁻ to be located either anti or syn with respect to Q²⁻.

L₂ and L₄⁻ are any ligands, for example those disclosed in WO-96/24629. They are often hetero-atom-containing solvents which supplement the ligands Q²⁻ and L₁ or L₃⁻ at free coordination sites. Their number depends upon the transition metal, the oxidation number thereof and the nature especially of L₁ or L₃⁻. Preferably, however, where applicable L₂, independently of L₁, is a further ligand L₁, and L₄⁻, independently of L₃⁻, is a further ligand L₃⁻. Especially p and q are 1 and L₁ is identical to L₂ and L₃⁻ is identical to L₄⁻.

L₁ contains a sub-structure N—C or P—C, which may be singly or, preferably, doubly unsaturated or part of a saturated or, preferably, unsaturated ring.

Examples of heterocyclic ligands L₁ are pyrrole, imidazole, pyrazole, pyridine, pyrazine, pyrimidine, pyridazine, indole, isoindole, indolizine, indazole, purine, quinolizine, quinoline, isoquinoline, 1,8-naphthyridine, phthalazine, quinoxaline, quinazoline, cinnoline, pteridine, carbazole, β-carboline, acridine, phenanthridine, perimidine, 1,7-phenanthroline, phenazine, phenarsazine, phenothiazine, phenoxazine, oxazole, isoxazole, phosphindole, thiazole, isothiazole, furazan, pyrrolidine, piperidine, 2-pyrroline, 3-pyrroline, imidazolidine, 2-imidazoline, 4-imidazoline, pyrazolidine, 2-pyrazoline, 3-pyrazoline, piperidine, piperazine, indoline, isoindoline, quinuclidine, morpholine, 1,2,3-triazole, 1,2,4-triazole, benzotriazole, phosphinoline and phosphindoline, each of which may be unsubstituted or substituted by R₉.

However, preferred ligands L₁ are nitriles, isonitriles, fulminates, cyanates, isocyanates, thiocyanates, isothiocyanates, azomethines, oximes, hydrazones, semi-carbazones, imines, amidines and amidoximes. Bonded to those functional groups are preferably linear or branched C₁-C₂₄alkyl, C₃-C₁₂cycloalkyl, C₇-C₂₄aralkyl, C₆-C₁₀aryl or C₄-C₉heteroaryl, each of which may be unsubstituted or substituted.

Preferred ligand anions L₃^{—} and L₄⁻ are CN⁻, SCN⁻ and NCS⁻, especially in formula (Ic) with primary, secondary, tertiary or quaternary ammonium as counter-ion

$${X}_{\frac{4 - m}{n}}^{n} .$$

L₁ is very especially an isonitrile of formula R₁₅—N⁺≡C⁻, wherein R₁₅ is unsubstituted or substituted, linear or branched C₁-C₂₄alkyl, C₃-C₁₂cycloalkyl, C₇-C₂₄aralkyl, C₆-C₁₀ aryl or C₄-C₉heteroaryl. Substituents thereof, where applicable, are e.g. the same as for R₁₁ or R₁₂.

Counter-ions wherein n is a number −2 or −1 are anions; those wherein n is a number +1 or +2 are cations. The superscript n is the charge of the counter-ion, the signs being regarded as equivalent whether written before or after the number. When the number n is in quotient, it is customary to omit a positive sign for the sake of clarity.

$${X}_{\frac{2 - m}{n}}^{n} , {X}_{\frac{3 - m}{n}}^{n} and {X}_{\frac{4 - m}{n}}^{n}$$

advantageously denote an inorganic, organic or organo-metallic counter-ion in the stoichiometry necessary for balancing the charge, for example the anion of a mineral acid or the conjugate base of an organic acid, for example fluoride, chloride, bromide, iodide, perchlorate, periodate, nitrate, ½ carbonate, hydrogen carbonate, C₁-C₄alkyl sulfate, ½ sulfate, hydrogen sulfate, monoalkali metal sulfate, methanesulfonate, trifluoromethanesulfonate, ½ monoalkali metal phosphate, dialkali metal phosphate, ½ hydrogen phosphate, dihydrogen phosphate, hexafluoroantimonate, hexafluorophosphate, ½ C₁-C₄alkane-phosphonate, C₁-C₄alkane-C₁-C₁₂alkyl-phosphonate, di-C₁-C₄alkylphosphinate, tetraphenylborate, tetrafluoroborate, acetate, trifluoroacetate, heptafluorobutyrate, ½ oxalate, benzenesulfonate, tosylate, p-chlorobenzenesulfonate, p-nitrobenzene-sulfonate, an alcoholate, phenolate (e.g. phenolate itself), carboxylate (also e.g. benzoate), sulfonate or phosphonate, or a cation such as H⁺, Li⁺, K⁺, Na⁺, Mg⁺², Ca⁺², Sr⁺², Al⁺³ or primary, secondary, tertiary or quaternary ammonium, for example 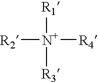
wherein R₁′, to R₄′, independently of R₁ to R₄, may be further radicals R₁ to R₄, preferably H or C₁-C₂₄alkyl, C₂-C₂₄alkenyl, C₃-C₂₄cycloalkyl, C₇-C₂,aralkyl or C₆-C₁₀aryl, which may be unsubstituted or substituted by hydroxy and uninterrupted or interrupted one or more times by oxygen.

Phenolates or carboxylates are, for example, anions of C₁-C₁₂alkylated, especially tert-C₄-C₈alkylated phenols and benzoic acids, such as

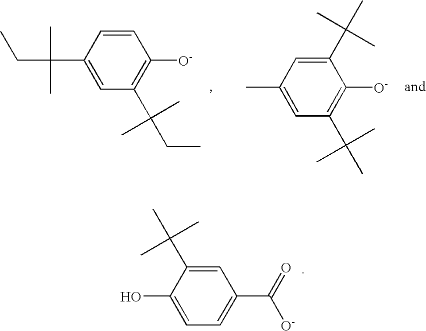

The person skilled in the art will readily recognise that it is also possible to use other counter-ions with which he is familiar. When

$$\frac{2 - m}{n} , \frac{3 - m}{n} or \frac{4 - m}{n}$$

is not equal to zero, it will be understood as indicating the number of cations or anions X having n charges, for example ½·SO₄²⁻ (n=−2) or ½·Mg²⁺ (n=+2). A multiply charged counter-ion is able to neutralise several singly charged cations or anions or one multiply charged cation or anion, as the case may be, it also being possible, for example, for dimers to be formed.

When

$${X}_{\frac{2 - m}{n}}^{n} , {X}_{\frac{3 - m}{n}}^{n} or {X}_{\frac{4 - m}{n}}^{n}$$

is an organometallic anion, it is preferably a metal complex of the formula [(L₅)E₁(L₆)]ⁿ⁻ (III) or [(L₇)E₂(L₈)]⁻ (IV), wherein E₁ and E₂ are a transition metal, E₁ preferably being Cr³⁺ or Co³⁺ and E₂ preferably being Ni²⁺, Co²⁺ or Cu²⁺, n is a number from 1 to 6, L₅ and L₆ are each independently of the other a ligand of formula 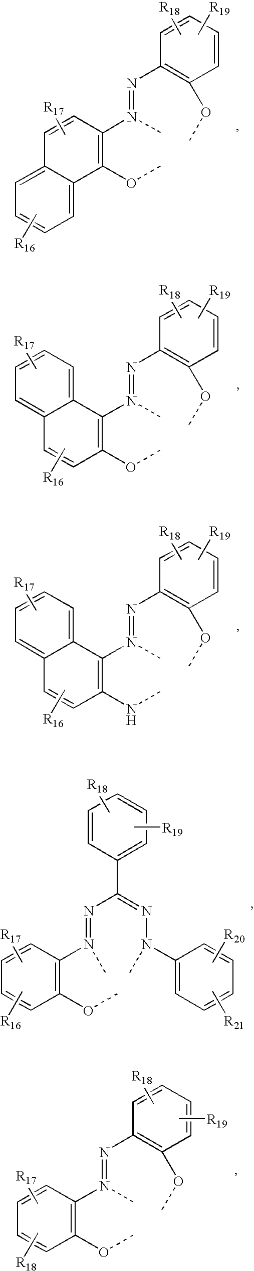 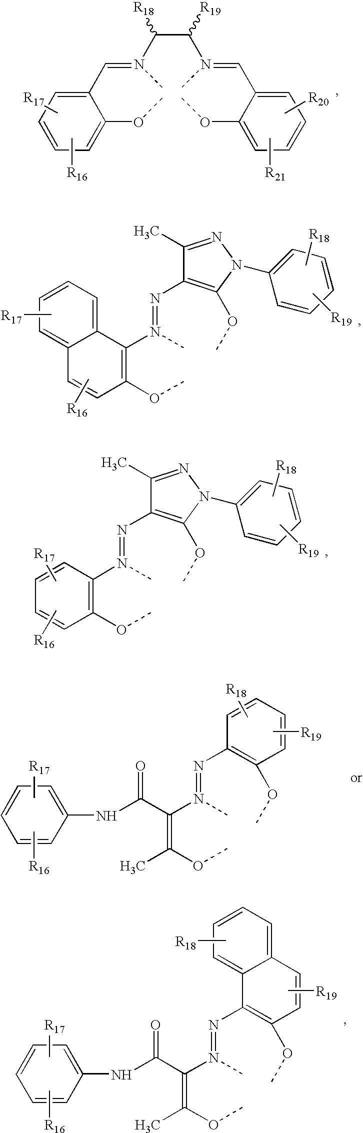
and L₇ and L₈ are each independently of the other a ligand of formula 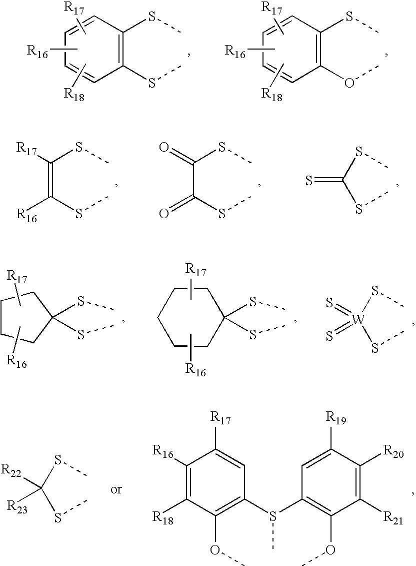
wherein
R₁₆, R₁₇, R₁₈, R₁₉, R₂₀ and R₂₁ are each independently of the others hydrogen, halogen, cyano, R₂₄, NO₂, NR₂₄R₂₅, NHCO—R₂₄, NHCOOR₂₄, SO₂—R₂₄, SO₂NH₂, SO₂NHR₂₄, SO₂NR₂₄R₂₅, SO₃^{- or SO}₃H, preferably hydrogen, chlorine, SO₂NH₂ or SO₂NHR₂₄, and R₂₂ and R₂₃ are each independently of the other CN, CONH₂, CONHR₂₄, CONR₂₄R₂₅, COOR₂₄ or COR₂₄, wherein R₂₄ and R₂₅ are each independently of the other C₁-C₁₂alkyl, C₁-C₁₂alkoxy-C₂-C₁₂alkyl, C₇-C₁₂aralkyl or C₆-C₁₂aryl, preferably C₁-C₄alkyl, each unsubstituted or substituted by hydroxy, halogen, sulfato, C₁-C₆alkoxy, C₁-C₆alkylthio, C₁-C₆alkylamino or by di-C₁-C₆alkylamino, or R₂₄ and R₂₅ together are C₄-C₁₀heterocycloalkyl; it also being possible for R₁₆ and R₁₇, R₁₈and R₁₉, and/or R₂₀ and R₂, to be bonded together in pairs in such a manner that a 5- or 6-membered ring is formed.

Reference is made by way of illustration, but on no account as a limitation, to the individual compounds disclosed in U.S.-Pat. No. 5,219,707, JP-A-06/199045 and JP-A-071262604.

$${X}_{\frac{2 - m}{n}}^{n} , {X}_{\frac{3 - m}{n}}^{n} or {X}_{\frac{4 - m}{n}}^{n}$$

as an organometallic anion is preferably

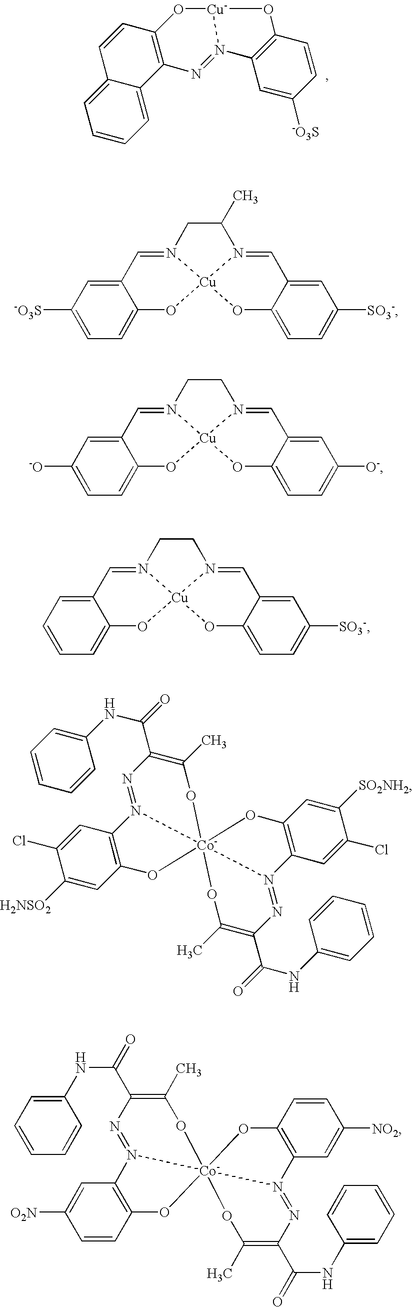

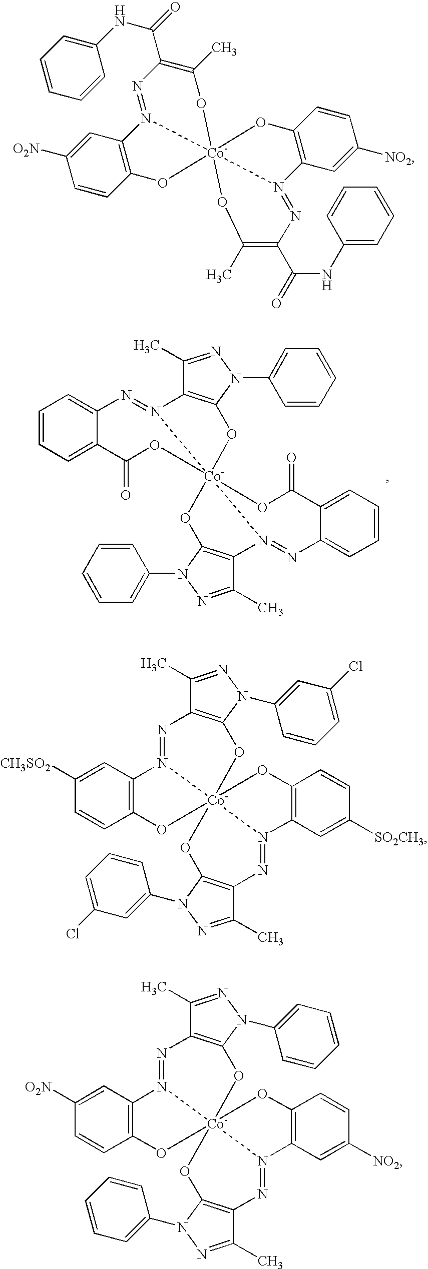

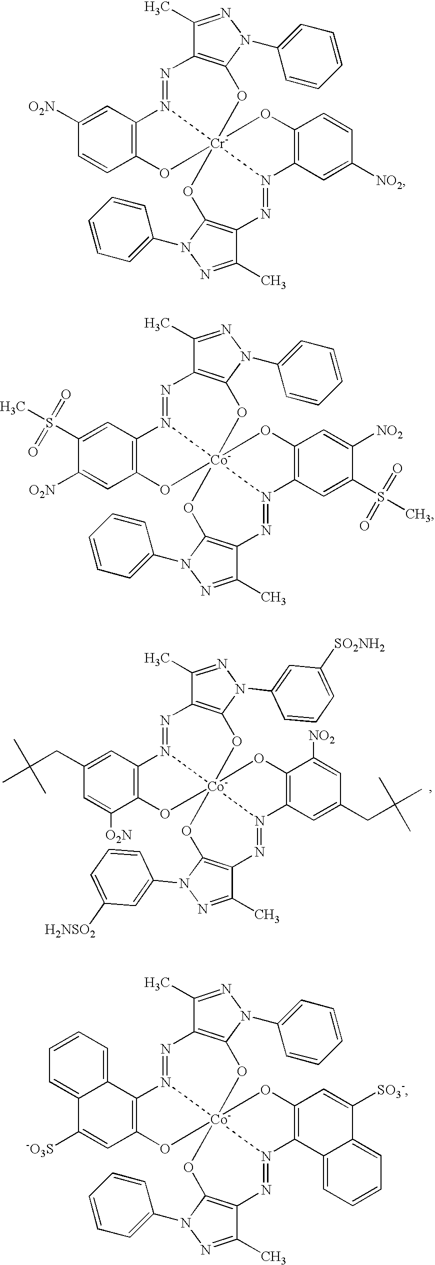

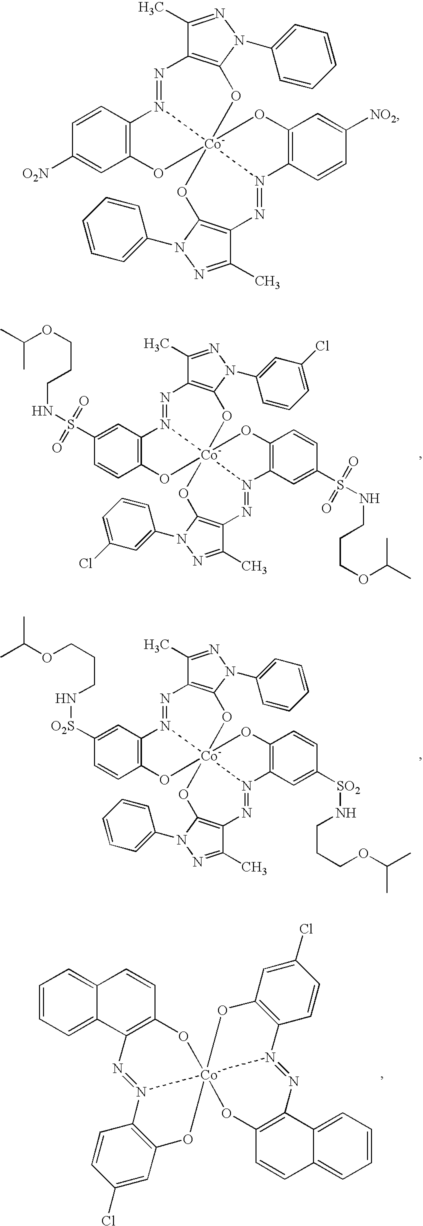

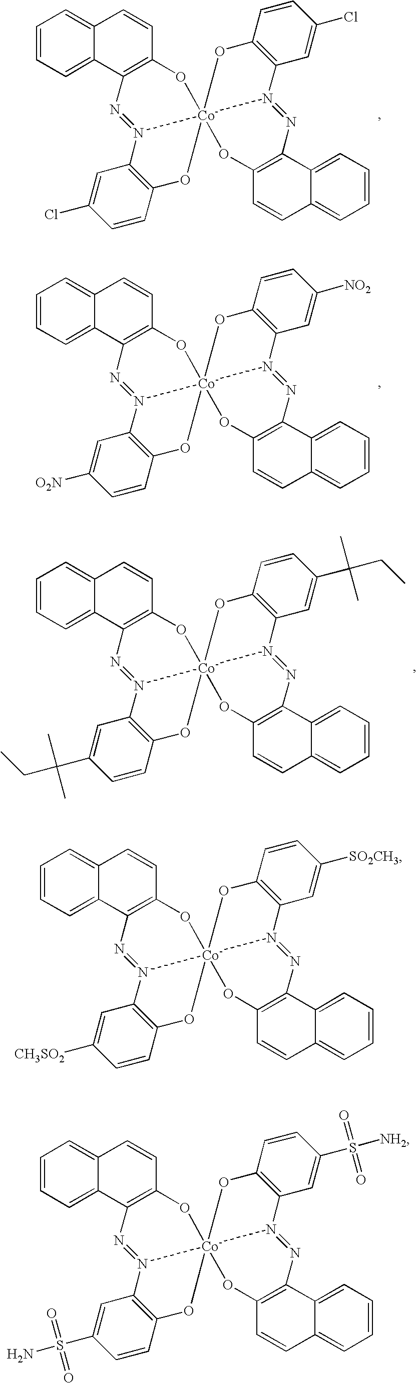

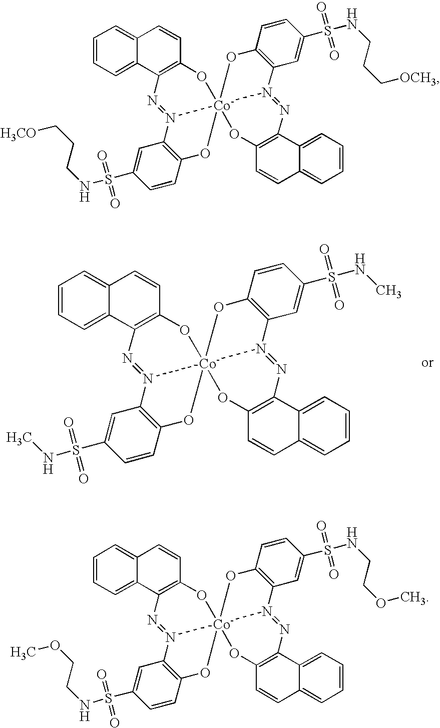

It is also possible, however, to use any other known transition metal complex anion that contains, for example, a phenolic or phenylcarboxylic azo compound as ligand L₅ or L₆.

Most of the ligands Q²⁺, L₁, L₂, L₃⁻, L₄⁻, L₅, L₆, L₇ and L₈ used in accordance with the invention are known; for example some Q²⁺ are known from Transition Met. Chem. 14, 341-346 (1989), Russian Journal of Coordination Chemistry 23/9, 623-628 (1997) or Russian Journal of General Chemistry 69/2, 308-313 (1999); some are new, however, it being possible for them to be prepared from known compounds using methods known per se.

The complexes of formulae (Ia), (Ib) and (Ic) according to the invention surprisingly have, in the form of a solid film, as used in optical storage media, an aggregation tendency that is surprisingly low for such compounds and two narrow and intense absorption bands having maxima at from 320 to 420 nm and at from 540 to 640 nm, with an especially steep gradient of the absorption band on the long wavelength side. At the respective longer wavelength flank of the absorption bands the refractive index is high and preferably achieves a peak value of from 1.8 to 2.5 in the range of from 380 to 450 nm and of from 2.0 to 3.0 in the range of from 600 to 700 nm, so that a medium having high reflectivity as well as high sensitivity and good playback characteristics in the desired spectral range can be achieved. The reflectivity of the layers in the range of the writing and reading wavelength is high in the unwritten state.

By virtue of those excellent layer properties it is possible to obtain a rapid optical recording having high sensitivity, high reproducibility and geometrically very precisely defined marks, the refractive index and the reflectivity changing substantially, which gives a high degree of contrast. The differences in the mark lengths and the interval distances (“jitter”) are very small, which enables a high storage density to be obtained using a relatively thin recording groove with a narrow track spacing (“pitch”). In addition, the recorded data can be reproduced with an astonishingly low error rate, so that error correction requires only a small amount of storage space.

By virtue of the solubility, including in apolar solvents, solutions can be used even in high concentrations without troublesome precipitation, for example during storage, so that problems during spin-coating are largely eliminated.

The substrate, which functions as support for the layers applied thereto, is advantageously semi-transparent (T≧10%) or preferably transparent (T≧90%). The support can have a thickness of from 0.01 to 10 mm, preferably from 0.1 to 5 mm.

The recording layer is preferably arranged between the transparent substrate and the reflecting layer. The thickness of the recording layer is from 10 to 1000 nm, preferably from 30 to 300 nm, especially about 80 nm, for example from 60 to 120 nm. The absorption of the recording layer is typically from 0.1 to 1.0 at the absorption maximum. The layer thickness is very especially so selected in known manner in dependence upon the respective refractive indices in the non-written state and in the written state at the reading wavelength that, in the non-written state, constructive interference is obtained but, in the written state, destructive interference is obtained, or vice versa.

The reflecting layer, the thickness of which can be from 10 to 150 nm, preferably has high reflectivity (R≧50%, especially R≧60%), coupled with low transparency r(T≧10%). In further embodiments, for example in the case of media having a plurality of recording layers, the reflector layer may likewise be semi-transparent, that is to say may have comparatively high transparency (for example T≧50%) and low reflectivity (for example R≧45%).

The uppermost layer, for example the reflective layer or the recording layer, depending upon the layer structure, is advantageously additionally provided with a protective layer having a thickness of from 0.1 to 1000 μm, preferably from 0.1 to 50 μm, especially from 0.5 to 15 μm. Such a protective layer can, if desired, serve also as adhesion promoter for a second substrate layer applied thereto, which is preferably from 0.1 to 5 mm thick and consists of the same material as the support substrate.

The reflectivity of the entire recording medium is preferably at least 15%, especially at least 40%.

The main features of the recording layer according to the invention are the very high initial reflectivity in the said wavelength range of the laser diodes, which can be modified with especially high sensitivity; the high refractive index; the narrow absorption band in the solid state; the good uniformity of the script width at different pulse durations; the good light stability; and the good solubility in polar solvents.

The use of dyes of formula (Ia), (Ib) or (Ic) results in advantageously homogeneous, amorphous and low-scatter recording layers having a high refractive index, and the absorption edge is surprisingly especially steep even in the solid phase. Further advantages are high light stability in daylight and under laser radiation of low power density with; at the same time, high sensitivity under laser radiation of high power density, uniform script width, high contrast, and also good thermal stability and storage stability.

The novel compounds are likewise to be regarded as a subject of the invention.

The invention therefore relates also to a complex of formula

$$\begin{matrix}\{ [ {Q}^{2 -} ] \cdot [ {M}^{m +} ] \cdot [ {L}_{1} ] {( \cdot [ {L}_{2} ] )}_{p} \} {X}_{\frac{2 - m}{n}}^{n} , & ( Ia ) \\ \{ [ {Q}^{2 -} ] \cdot [ {M}^{m +} ] \cdot [ {L}_{3}^{-} ] {( \cdot [ {L}_{2} ] )}_{p} \} {X}_{\frac{3 - m}{n}}^{n} or & ( Ib ) \\ \{ [ {Q}^{2 -} ] \cdot [ {M}^{m +} ] \cdot [ {L}_{3}^{-} ] \cdot [ {L}_{4}^{-} ] \} {X}_{\frac{4 - m}{n}}^{n} , & ( Ic )\end{matrix}$$

wherein
Q²⁻ is a ligand of formula 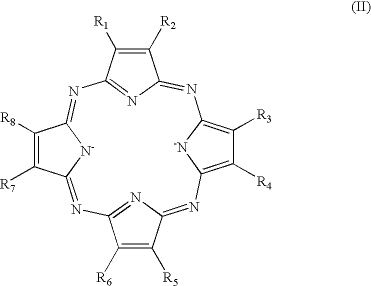
   or a tautomer thereof,
and R₁, R₂, R₃, R₄, R₅, R₆, R₇ and R₈ are each independently of the others H, halogen, cyano, COOR₉, CONHR₉, CONR₉R₁₀, R₉, OR₉, SR₉, NHR₉ or NR₉R₁₀, wherein R₉ and R₁₀ are each independently of the other C₆-C₁₀aryl, C₄-C₉heteroaryl or linear or branched C₁-C₂₄alkyl, C₃-C₂₄cycloalkyl, C₂-C₂₄alkenyl, C₃-C₂₄cycloalkenyl, C₂-C₂₄alkynyl, C₁-C₁₂heterocycloalkyl, C₁-C₁₂heterocycloalkenyl, C₇-C₂₄aralkenyl or C₇-C₂₄aralkyl, each of which may be unsubstituted or substituted, it also being possible for R₁ and R₂, R₃ and R₄, R₅ and R₆, and R₇ and R₈, independently of one another, to be bonded by a direct bond or via a bridge O or S,
M^{m+} is a transition metal cation having 5 or 6 electrons in the outermost occupied d-shell,
L₁ is a ligand having a sub-structure N—C, P—C or As—C,
L₂, independently of L₁, is a further ligand containing at least one hetero atom N, P, As, O, S, Se or Te,
L₃⁻ is CN⁻, SCN⁻, NCS⁻, OCN⁻, NCO⁻, N₃⁻, L₁-O⁻, L₁-S⁻, L₁-CO₂⁻, L₁-SO₃⁻ or L₁-PO₃⁻,
L₄⁻, independently of L₃⁻, is CN⁻, SCN⁻, NCS⁻, OCN⁻, NCO⁻, N₃⁻, L₃-O⁻, L₃-S⁻, L₃-CO₂⁻, L₃-SO₃⁻ or L₃-PO₃⁻,
p and q are each independently of the other a number 0 or 1,

$${X}_{\frac{2 - m}{n}}^{n} , {X}_{\frac{3 - m}{n}}^{n} and {X}_{\frac{4 - m}{n}}^{n}$$

are each a counter-ion, m is a number 1, 2, 3 or 4 equal to the positive charge in M^{m+} and n is a number −2, −1, +1 or +2, so that the quotient

$$\frac{2 - m}{n} , \frac{3 - m}{n} or \frac{4 - m}{n}$$

is not negative, with the exception of those wherein
R₁, R₂, R₃, R₄, R₅, R₆, R₇ and R₈ are all phenyl, M is Fe(n), Ru(II) or Os(II) and L₁ and L₂ are both pyridine, or
R₁, R₂, R₃, R₄ , R₅, R₆, R₇ and R₈ are all phenyl or p-tert-butyl-phenyl, M is Fe(II) and L₁ and L₂ are pyrazine, tert-butylisocyanide, cyclohexylisocyanide, phenyl-isocyanide or 2,3,5,6-tetramethyidiisocyanobenzene.

At a relatively high recording speed, the results obtained are surprisingly better than with previously known recording media. The marks are more precisely defined relative to the surrounding medium, and thermally induced deformations do not occur. The error rate (PI sum 8, formerly BLER) and the statistical variations in mark length (Citter) are also low both at normal recording speed and at relatively high recording speed, so that an error-free recording and playback can be achieved over a large speed range. There are virtually no rejects even at high recording speed, and the reading of written media is not slowed down by the correction of errors. The advantages are obtained in the entire range of from 600 to 700 nm, preferably from 630 to 690 nm, especially from 650 to 670 nm, particularly at 658±5 nm.

Suitable substrates are, for example, glass, minerals, ceramics and thermosetting or thermoplastic plastics. Preferred supports are glass and homo- or co-polymeric plastics. Suitable plastics are, for example, thermoplastic polycarbonates, polyamides, polyesters, polyacrylates and polymethacrylates, polyurethanes, polyolefins, polyvinyl chloride, polyvinylidene fluoride, polyimides, thermosetting polyesters and epoxy resins. The substrate can be in pure form or may also comprise customary additives, for example UV absorbers or dyes, as proposed e.g. in JP 04/167 239 as light-stabilisers for the recording layer. In the latter case it may be advantageous for the dye added to the support substrate to have an absorption maximum hypsochromically shifted relative to the dye of the recording layer by at least 10 nm, preferably by at least 20 nm.

The substrate is advantageously transparent over at least a portion of the range from 600 to 700 nm (preferably as indicated above), so that it is permeable to at least 90% of the incident light of the writing or readout wavelength. The substrate has preferably on the coating side a spiral guide groove having a groove depth of from 50 to 500 nm, a groove width of from 0.2 to 0.8 μm and a track spacing between two turns of from 0.4 to 1.6 μm, especially having a groove depth of from 100 to 200 nm, a groove width of 0.3 μm and a spacing between two turns of from 0.6 to 0.8 μm. The storage media according to the invention are therefore suitable especially advantageously for the optical recording of DVD media having the currently customary mark width of 0.4 μm and track spacing of 0.74 μm. The increased recording speed relative to known media allows synchronous recording or, for special effects, even accelerated recording of video sequences with excellent image quality.

The recording layer, instead of comprising a single compound of formula (Ia), (Ib) or (Ic), may also comprise a mixture of such compounds having, for example, 2, 3, 4 or 5 porphyrazine dyes according to the invention. By the use of mixtures, for example mixtures of isomers or homologues as well as mixtures of different structures, the solubility can often be increased and/or the amorphous content improved. If desired, mixtures of ion pair compounds may have different anions, different cations or both different anions and different cations.

For a further increase in stability it is also possible, if desired, to add known stabilisers in customary amounts, for example a nickel dithiolate described in JP 04/025 493 as light stabiliser.

The recording layer comprises a compound of formula (Ia), (Ib) or (Ic) or a mixture of such compounds advantageously in an amount sufficient to have a substantial influence on the refractive index, for example at least 30% by weight, preferably at least 60% by weight, especially at least 80% by weight. The recording layer may especially valuably comprise a compound of formula (Ia), (Ib) or (Ic) or a mixture of a plurality of such compounds as main component, or may consist exclusively or substantially of one or more compounds of formula (Ia), (Ib) or (Ic).

Further customary constituents are possible, for example other chromophores (for example those having an absorption maximum at from 300 to 1000 nm), UV absorbers and/or other stabilisers, free radical capture agents (e.g. for ¹O₂) or luminescence-quenchers, melting-point reducers, decomposition accelerators or any other additives that have already been described in optical recording media, for example film-formers.

When the recording layer comprises further chromophores, such chromophores may in principle be any dyes that can be decomposed or modified by the laser radiation during the recording, or they may be inert towards the laser radiation. When the further chromophores are decomposed or modified by the laser radiation, this can take place directly by absorption of the laser radiation or can be induced indirectly by the decomposition of the compounds of formula (Ia), (Ib) or (Ic) according to the invention, for example thermally.

Naturally, further chromophores or coloured stabilisers may influence the optical properties of the recording layer. It is therefore preferable to use further chromophores or coloured stabilisers, the optical properties of which conform as far as possible to, or are as different as possible from, those of the compounds of formula (Ia), (Ib) or (Ic), or the amount of further chromophores is kept small.

When further chromophores having optical properties that conform as far as possible to those of compounds of formula (Ia), (Ib) or (Ic) are used, preferably this should be the case in the range of the longest-wavelength absorption flank. Preferably the wavelengths of the inversion points of the further chromophores and of the compounds of formula (Ia), (Ib) or (Ic) are a maximum of 40 nm, especially a maximum of 20 nm, apart. In that case the further chromophores and the compounds of formula (Ia), (Ib) or (Ic) should exhibit similar behaviour in respect of the laser radiation, so that it is possible to use as further chromophores known recording agents the action of which is synergistically enhanced or heightened by the compounds of formula (Ia), (Ib) or (Ic).

When further chromophores or coloured stabilisers having optical properties that are as different as possible from those of compounds of formula (Ia), (Ib) or (Ic) are used, they advantageously have an absorption maximum that is hypsochromically or bathochromically shifted relative to the dye of formula (Ia), (Ib) or (Ic). In that case the absorption maxima are preferably at least 50 nm, especially at least 100 nm, apart. Examples thereof are UV absorbers that are hypsochromic to the dye of formula (Ia), (Ib) or (Ic), or coloured stabilisers that are bathochromic to the dye of formula (Ia), (Ib) or (Ic) and have absorption maxima lying, for example, in the NIR or IR range. Other dyes can also be added for the purpose of colour-coded identification, colour-masking (“diamond dyes”) or enhancing the aesthetic appearance of the recording layer.

When another chromophore is added in order to modify the optical properties of the compounds of formula (Ia), (Ib) or (Ic), the amount thereof is dependent upon the optical properties to be achieved. The person skilled in the art will find little difficulty in varying the ratio of additional dye to compound of formula (Ia), (Ib) or (Ic) until he obtains his desired result. The ratio by weight of compounds or formula (Ia), (Ib) or (Ic) to other chromophores is generally from 1:99 to 99:1, preferably from 1:95 to 95:1, especially from 30:70 to 70:30, more especially from 40:60 to 60:40, for example 50:50.

Further chromophores that can be used in the recording layer in addition to the compounds of formula (Ia), (Ib) or (Ic) advantageously have, in solid form, a maximum absorption (αₘₐₓ) in the range of from 350 to 620 nm. Examples are cyanines and cyanine metal complexes (U.S. Pat. No. 5,958,650), styryl compounds (U.S. Pat. No. 6,103,331), oxonol dyes (EP-A-0 833 314), azo dyes and azo metal complexes (JP-A-11/028865), phthalocyanines (EP-A-0 232 427, EP-A-0 337 209, EP-A-0 373 643, EP-A-0 463 550, EP-A-0 492 508, EP-A-0 509 423, EP-A-0 511 590, EP-A-0 513 370, EP-A-0 514 799, EP-A-0 518 213, EP-A-0 519 419, EP-A-0 519 423, EP-A-0 575 816, EP-A-0 600 427, EP-A-0 676 751, EP-A-0 712 904, WO-98/14520, WO-00/09522, PCT/EP-02/03945), porphyrins, dipyrromethene dyes and metal chelate compounds thereof (EP-A-0 822 544, EP-A-0 903 733), xanthene dyes and metal complex salts thereof (U.S. Pat. No. 5,851,621) or quadratic acid compounds (EP-A-0 568 877), also oxazines, dioxazines, diazastyryls, formazans, anthraquinones or phenothiazines or other porphyrazines (EP-A-0 822 546, U.S. Pat. No. 5,998,093, JP-A-2001/277723); this list is on no account exhaustive and the person skilled in the art will interpret the list as including further known dyes, for example those disclosed in WO 01/75873.

It has astonishly been found that mixtures of compounds of formula (Ia), (Ib) or (Ic) with other chromophores which, in solid form, have a maximum absorption (λₘₐₓ) in the range of from 350 to 620 nm exhibit improved light stability in respect of ultraviolet (UV) and visible (VIS) light compared with the pure components. By the addition of compounds of formula (Ia), (Ib) or (Ic), other chromophores are surprisingly efficiently stabilised.

The invention therefore relates also to a solid substance composition comprising a compound of formula (Ia), (Ib) or (Ic) and another chromophore which, in solid form, exhibits a maximum absorption (%max) in the range of from 350 to 620 nm, the ratio by weight of the compound of formula (Ia), (Ib) or (Ic) to the other chromophore being from 1:99 to 99:1, preferably from 1:95 to 95:1, especially from 30:70 to 70:30, and more especially from 40:60 to 60:40. It is also possible for a plurality of compounds of formula (Ia), (Ib) or (Ic) and/or a plurality of other chromophores to be present. In that case, the calculation of the ratio by weight should be based on the total weight of all compounds of formula (Ia), (Ib) or (Ic) and on the total weight of all the other chromophores. Other chromophores are substances that have a molar extinction coefficient E of at least 5000 at λₘₐₓ but do not correspond to formula (Ia), (Ib) or (Ic). Solid substances have a melting point of at least 25° C. or more, or they decompose thermally without melting.

In the substance compositions, the components are preferably inseparably bonded to one another, for example in the form of a solid solution or a mass, wherein preferably amorphous areas of the components in question have at least one common interface. For example, there may also be inclusions of one component in a matrix of the other component, in which case one or both of the components may, independently of one another, be crystalline, preferably partially crystalline or especially amorphous. The areas or inclusions may be individual molecules, as, for example, in a mixed crystal, or may comprise several molecules of the same component, for example they may have a volume of from 10⁻²⁶ to 10⁻⁸ m³, preferably from 10⁻²⁴ to 10⁻¹⁹ m³.

Especially outstanding, synergistic results are obtained when the other chromophore has the base structure 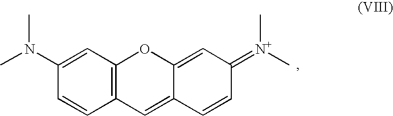
which may be unsubstituted or substituted by any monodentate or bidentate radicals. Of course, bidentate radicals give rise to additional rings. Special preference is given to the chromophores having the base structure (VIII) that are disclosed in U.S. Pat. No. 5,851,621.

When chromophores or coloured stabilisers are used for other purposes, the amount thereof should preferably be small so that their contribution to the total absorption of the recording layer in the range of from 600 to 700 nm is a maximum of 20%, preferably a maximum of 10%. In such a case, the amount of additional dye or stabiliser is advantageously a maximum of 50% by weight, preferably a maximum of 10% by weight, based on. the recording layer.

In a further, special embodiment, instead of an additional chromophore a coloured stabiliser is added to the compound of formula (Ia), (Ib) or (Ic).

Stabilisers, free radical capture agents or luminescence-quenchers are, for example, metal complexes of N- or S-containing enolates, phenolates, bisphenolates, thiolates or bisthiolates or of azo, azomethine or formazan dyes, such as ®Irgalan Bordeaux EL, ®Cibafast N or similar compounds, hindered phenols and derivatives thereof (optionally also as counter-ions

$$\frac{{X}_{2 - m}^{n}}{n} , \frac{{X}_{3 - m}^{n}}{n} or \frac{{X}_{4 - m}^{n}}{n} ) ,$$

such as ®Cibafast AO, o-hydroxy-phenyl-triazoles or -triazines or other UV absorbers, such as ®Cibafast W or ®Cibafast P or hindered amines (TEMPO or HALS, also as nitroxides or NOR-HALS, optionally also as counter-ions

$$\frac{{X}_{2 - m}^{n}}{n} , \frac{{X}_{3 - m}^{n}}{n} or \frac{{X}_{4 - m}^{n}}{n} ) ,$$

and also as cations diimmonium, Paraquat™ or Orthoquat™ salts, such as ®Kayasorb IRG 022 or ®Kayasorb IRG 040. ®Irgalan and ®Cibafast brands are from Ciba Spezialitatenchemie AG, ®Kayasorb brands from Nippon Kayaku Co. Ltd.

Many such structures are known, some of them also in connection with optical recording media, for example from U.S. Pat. No. 5,219,707, JP-A-06/199045, JP-A-07/76169 or JP-A-07/262604. They may be, for example, salts of the metal complex anions disclosed above with any desired cations, for example the cations disclosed above.

Also suitable are neutral metal complexes, for example those of formula (L₇)E₂(L₉) (V), (L₁₀)E₂(L₁₁) (VI) or E₂(L₁₂) (VII), wherein L₉ is C₁-C₁₂alkyl-OH, C₆-C₁₂aryl-OH, C₇-C₁₂aralkyl-OH, C₁-C₁₂alkyl-SH, C₆-C₁₂aryl-SH, C₇-C₁₂aralkyl-SH, C₁-C₁₂alkyl-NH₂, C₆-C₁₂aryl-NH₂, C₇-C₁₂aralkyl-NH₂, di-C₁-C₁₂alkyl-NH, di-C₆-C₁₂aryl-NH, di-C₇-C₁₂aralkyl-NH, tri-C₁-C₁₂alkyl-N, tri-C₆-C₁₂aryl-N or tri-C₇-C₁₂aralkyl-N, 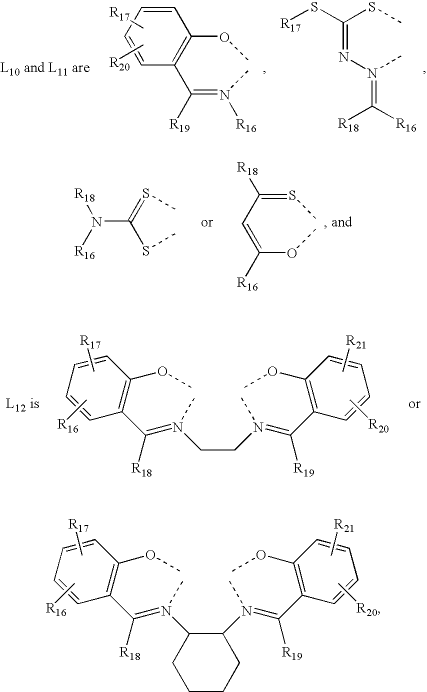
E₂ and R₁₆to R₂₁ being as defined above.

A particular example of an additive of formula (VII) that may be mentioned is a copper complex, illustrated e.g. by a compound of formula

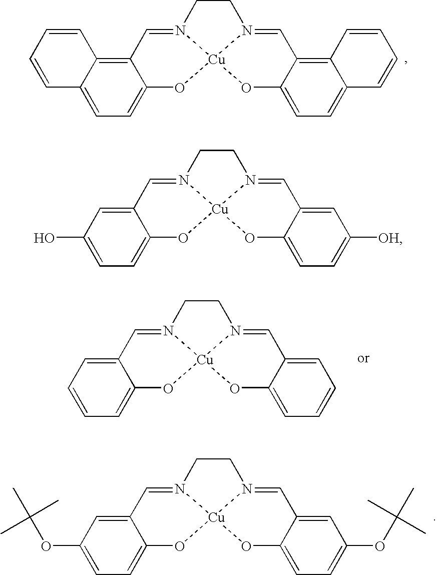

A particular example of an additive of formula (V) that may be mentioned is a nickel bisphenolate, e.g. the compound of formula

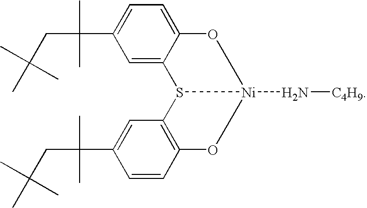

The person skilled in the art will know from other optical information media, or will easily identify, which additives in which concentration are especially well suited to which purpose. Suitable concentrations of additives are, for example, from 0.001 to 1000% by weight, preferably from 1 to 50% by weight, based on the recording medium of formula (Ia), (Ib) or (Ic).

The recording medium according to the invention, in addition to comprising the compounds of formula (Ia), (Ib) or (Ic), may additionally comprise salts, for example ammonium chloride, pentadecylammonium chloride, sodium chloride, sodium sulfate, sodium methyl sulfonate or sodium methyl sulfate, the ions of which may originate e.g. from the components used. The additional salts, if present, may be present preferably in amounts of up to 20% by weight, based on the total weight of the recording layer.

Reflecting materials suitable for the reflective layer include especially metals, which provide good reflection of the laser radiation used for recording and playback, for example the metals of Main Groups m, IV and V and of the Sub-Groups of the Periodic Table of the Elements. Al, In, Sn, Pb, Sb, Bi, Cu, Ag, Au, Zn, Cd, Hg, Sc, Y, La, Ti, Zr, Hf, V, Nb, Ta, Cr, Mo, W, Fe, Co, Ni, Ru, Rh, Pd, Os, Ir, Pt, Ce, Pr, Nd, Pm, Sm, Eu, Gd, Tb, Dy, Ho, Er, Tm, Yb and Lu and alloys thereof are especially suitable. Special preference is given to a reflective layer of aluminium, silver, copper, gold or an alloy thereof, on account of their high reflectivity and ease of production.

Materials suitable for the covering layer include chiefly plastics, which are applied in a thin layer to the support or to the uppermost layer either directly or with the aid of adhesive layers. It is advantageous to select mechanically and thermally stable plastics having good surface properties, which may be modified further, for example written. The plastics may be thermosetting plastics or thermoplastic plastics. Preference is given to radiation-cured (e.g using UV radiation) protective layers, which are particularly simple and economical to produce. A wide variety of radiation-curable materials are known. Examples of radiation-curable monomers and oligomers are acrylates and methacrylates of diols, triols and tetrols, polyimides of aromatic tetracarboxylic acids and aromatic diamines having C₁-C₄alkyl groups in at least two ortho-positions of the amino groups, and oligomers with dialkylmaleinimidyl groups, e.g. dimethylmaleinimidyl groups. For covering layers that are applied using adhesion promoters it is preferable to use the same materials as those used for the substrate layer, especially polycarbonates. The adhesion promoters used are preferably likewise radiation-curable monomers and oligomers. Instead of the covering layer applied using an adhesion promoter there may also be used a second substrate comprising a recording and reflector layer, so that the recording medium is playable on both sides. Preference is given to a symmetrical structure, the two parts being joined together at the reflector side by an adhesion promoter directly or by way of an intermediate layer.

In such a structure, the optical properties of the covering layer, or of the covering materials, have essentially no role per se insofar as the curing thereof, where applicable, is achieved e.g. by UV radiation. The basic function of the covering layer is to ensure the mechanical strength of the recording medium as a whole and, if necessary, the mechanical strength of thin reflector layers. If the recording medium is sufficiently robust, for example when a thick reflector layer is present, it is even possible to dispense with the covering layer altogether. The thickness of the covering layer depends upon the thickness of the recording medium as a whole, which should preferably be a maximum of about 2 mm thick. The covering layer is preferably from 10 μm to 1 mm thick.

The recording media according to the invention may also have additional layers, for example interference layers. It is also possible to construct recording media having a plurality of (for example two) recording layers. The structure and the use of such materials are known to the person skilled in the art. Preferred, if present, are interference layers that are arranged between the recording layer and the reflecting layer and/or between the recording layer and the substrate and consist of a dielectric material, for example as described in EP-A-0 353 393 of TiO₂, Si₃N₄, ZnS or silicone resins.

The recording media according to the invention can be produced by processes known per se, it being possible for various methods of coating to be employed depending upon the materials used and their function.

Suitable coating methods are, for example, immersion, pouring, brush-coating, blade-application and spin-coating, as well as vapour-deposition methods carried out under a high vacuum. When, for example, pouring methods are used, solutions in organic solvents are generally employed. When solvents are employed, care should be taken that the supports used are insensitive to those solvents. Suitable coating methods and solvents are described, for example, in EP-A-0 401 791.

The recording layer is applied preferably by spin-coating with a dye solution, solvents that have proved satisfactory being especially alcohols, e.g. 2-methoxyethanol, n-propanol, isopropanol, isobutanol, n-butanol, amyl alcohol or 3-methyl-1 -butanol or, preferably, fluorinated alcohols, e.g. 2,2,2-trifluoroethanol or 2,2,3,3-tetrafluoro-1-propanol, and mixtures thereof. It will be understood that other solvents or solvent mixtures can also be used, for example those solvent mixtures described in EP-A-0 511 598 and EP-A-0 833 316. Ethers (dibutyl ether), ketones (2,6-dimethyl-4-heptanone, 5-methyl-2-hexanone) or saturated or unsaturated hydrocarbons (toluene, xylene) can also be used, for example in the form of mixtures (e.g. dibutyl ether/2,6-dimethyl-4-heptanone) or mixed components. Further suitable solvents are disclosed, for example, in EP-A-0 483 387.

The person skilled in the art of spin-coating will in general routinely try out all the solvents with which he is familiar, as well as binary and ternary mixtures thereof, in order to discover the solvents or solvent mixtures which result in a high-quality and, at the same time, cost-effective recording layer containing the solid components of his choice. Known methods of process engineering can also be employed in such optimisation procedures, so that the number of experiments to be carried out can be kept to a minimum. In the case of spin-coating, the layer obtained should preferably be as amorphous as possible.

The invention therefore relates also to a method of producing an optical recording medium, wherein a solution of a compound of formula (Ia), (Ib) or (Ic) in an organic solvent is applied to a substrate having one or more depressions, for example a disk with a spiral-shape groove of depth from 1 nm to 1 μm. The application is preferably carried out by spin-coating.

The application of the metallic reflective layer is preferably effected by sputtering, vapour-deposition in vacuo or by chemical vapour deposition (CVD). The sputtering technique is especially preferred for the application of the metallic reflective layer on account of the high degree of adhesion to the support. Such techniques are known and are described in specialist literature (e.g. J. L. Vossen and W. Kern, “Thin Film Processes”, Academic Press, 1978).

The structure of the recording medium according to the invention is governed primarily by the readout method; known function principles include the measurement of the change in transmission or, preferably, reflection, but it is also known, for example, to measure the fluorescence instead of the transmission or reflection.

When the recording material is structured for a change in reflection, the following structures, for example, can be used: transparent support/recording layer (optionally multilayered)/reflective layer and, if expedient, protective layer (not necessarily transparent); or support (not necessarily transparent)/reflective layer/recording layer and, if expedient, transparent protective layer. In the first case, the light is incident from the support side, whereas in the latter case the radiation is incident from the recording layer side or, where applicable, from the protective layer side. In both cases the light detector is located on the same side as the light source. The first-mentioned structure of the recording material to be used according to the invention is generally preferred.

When the recording material is structured for a change in light transmission, the following different structure, for example, comes into consideration: transparent support/recording layer (optionally multilayered) and, if expedient, transparent protective layer. The light for recording and for readout can be incident either from the support side or from the recording layer side or, where applicable, from the protective layer side, the light detector in this case always being located on the opposite side.

Suitable lasers are those having a wavelength of 600-700 nm, for example commercially available lasers having a wavelength of 602, 612, 633, 635, 647, 650, 670 or 680 nm, especially semi-conductor lasers, such as GaAsAl, InGaAlP or GaAs laser diodes having a wavelength especially of about 635, 650 or 658 nm.

The recording is effected, for example, point for point in a manner known per se, by modulating the laser in accordance with the mark lengths and focussing its radiation onto the recording layer. It is known from the specialist literature that other methods are currently being developed which may also be suitable for use.

The method according to the invention allows the storage of information with great reliability and stability, distinguished by very good mechanical and thermal stability and by high light stability and by sharp boundary zones of the marks. Special advantages include the high contrast, the low jitter and the surprisingly high signal/noise ratio, so that excellent readout is achieved. The high storage capacity is especially valuable in the field of video.

The readout of information is carried out according to methods known per se by registering the change in absorption or reflection using laser radiation, for example as described in “CD-Player und R-DAT Recorder” (Claus Biaesch-Wiepke, Vogel Buchverlag, Wurzburg 1992).

The information-containing medium according to the invention is especially an optical information material of the WORM type. It can be used, for example, as a playable DVD (digital versatile disk), as storage material for a computer or as an identification and security card or for the production of diffractive optical elements, for example holograms.

The invention accordingly relates also to a method for the optical recording, storage and playback of information, wherein a recording medium according to the invention is used. The recording and the playback take place, for example, in a wavelength range of from 600 to 700 nm.

Furthermore, the complexes of formula (Ia), (Ib) or (Ic) can advantageously also be used at a lower wavelength, so that a further increase in data density is possible if recording and reproduction take place at the same wavelength. In such a case it is preferable to use a simple optical system having a single laser source of e.g. from 350 to 500 nm, preferably from 370 to 450 nm. Especially preferred is in the UV range from 370 to 390 nm, especially about 380 nm, or especially at the edge of the visible range from 390 to 430 nm, especially about 405±5 nm. In the range of compact, blue or violet laser diodes (such as Nichia GaN 405 nm) having an optical system with a high numerical aperture, the marks can be made so small and the tracks so narrow that up to about 20 to 25 Gb per recording layer are achievable on a 120 mm disc. At 380 nm it is possible to use indium-doped UV-VCSELs (Vertical-Cavity Surface-Emitting Laser) which laser source already exists as a prototype Jung Han et al., see MRS Internet J. Nitride Semicond. Res. 5S1, W6.2 (2000)].

In addition, by virtue of the optical properties of the complexes of formula (Ia), (Ib) or (Ic), it is possible using a single laser for optical recording media that have been written at from 600 to 700 nm to be read at 350 to 500 nm, or vice versa (the data density then having to correspond to that of the higher wavelength). This astonishing and very advantageous polyvalence enables savings to be made in the construction of optical recording apparatus and the miniaturisation thereof.

In one embodiment the recording medium is based on the structure of known recording media and is, for example, constructed analogously to those mentioned above, writing and reading taking place through the substrate.

In such a case the substrate is advantageously transparent over at least a portion of the range from 350 to 500 nm, so that it is permeable to, for example, at least 80% of the incident light of the writing or readout wavelength. The substrate is advantageously from 10μm to 1 mm thick, preferably from 20 to 600 μm thick, especially from 20 to 600 μm thick, with a preferably spiral guide groove (track) on the coating side, a groove depth of from 10 to 200 nm, preferably from 80 to 150 nm, a groove width of from 100 to 400 nm, preferably from 150 to 250 nm, and a spacing between two turns of from 200 to 600 nm, preferably from 350 to 450 nm. Grooves of different cross-sectional shape are known, for example rectangular, trapezoidal or V-shaped. Analogously to the known CD-R and DVD-R media, the guide groove may additionally undergo a small periodic or quasi-periodic lateral deflection (wobble), so that the speed and the absolute positioning of the reading head (pick-up) can be synchronised. Instead of, or in addition to, the deflection, the same function can be performed by markings between adjacent grooves (pre-pits).

The recording layer is preferably from 0 to 30 nm thick, especially from 1 to 20 nm thick, more especially from 2 to 10 nm thick, on the surface (“land”) and, depending upon the geometry of the groove, advantageously from 20 to 150 nm thick, preferably from 50 to 120 nm thick, especially from 60 to 100 nm thick, in the groove.

The reflector layer is, for example, from 5 to 200 nm thick, preferably from 10 to 100 nm thick, especially from 40 to 60 nm thick, but reflector layers of greater thickness, for example 1 mm thick or even more, are also possible.

The recording media according to the invention may also have additional layers, for example interference layers or barrier layers. It is also possible to construct recording media having a plurality of (for example from two to ten) recording layers. The structure and the use of such materials are known to the person skilled in the art. Preferred, if present, are interference layers that are arranged between the recording layer and the reflecting layer and/or between the recording layer and the substrate and consist of a dielectric material, for example as described in EP-A-0 353 393 of TiO₂, Si₃N₄, ZnS or silicone resins.

The recording media according to the invention can be produced by processes known per se, it being possible for various methods of coating to be employed depending upon the materials used and their function.

The information-containing medium according to the invention is especially an optical information material of the WORM type. It may be used, for example, analogously to CD-R (compact disc-recordable) or DVD-R (digital video disc-recordable) in computers, and also as storage material for identification and security cards or for the production of diffractive optical elements, for example holograms.

In comparison with CD-R or DVD-R, however, the starting material for this structure is a very much thinner substrate, so that the manufacturing process is considerably more awkward. For the production of recording media having a high storage density and correspondingly small marks (“pits”), this has now proved necessary for precise focussing.

Preference is therefore given to an inverse layer structure having the layer sequence: substrate, reflector layer, recording layer and covering layer. The recording layer is therefore located between the reflector layer and the covering layer. Recording and playback therefore do not take place through the substrate but through the covering layer. Accordingly the respective roles of the covering layer and the substrate, especially the geometry and the optical properties, are reversed in comparison with the structure described above. Analogous concepts are described a number of times in Proceedings SPIE-Int. Soc. Opt. Eng. 1999, 3864 for digital video recordings in conjunction with a blue GaN laser diode.

The inverse layer structure places considerably higher demands on the recording substances, which the compounds used according to the invention fulfil astonishingly well. It is thus possible to apply over the solid recording layer, without making any significant changes thereto, a thin covering layer beneath which the recording substances are sufficiently well protected from rubbing, photo-oxidation, fingermarks, moisture and other environmental effects.

It is especially preferred to apply to the solid recording layer an additional, thin separating layer of a metallic, cross-linked organometallic or dielectric inorganic substance, for example in a thickness of from 0.001 to 10 μm, preferably from 0.005 to 1 μm, especially from 0.01 to 0.1 μm. On account of their high reflectivity, metallic separating layers should advantageously be a maximum of 0.03 μm thick.

Cross-linked organometallic or dielectric inorganic layers are known per se and consist, for example, of oxides, oxide hydrates or halides (especially fluorides), metals having an electronegativity of from 1 to 2, for example aluminium, zinc, zirconium, titanium, chromium, iron, cobalt, nickel and especially silicon, in oxidation state II to V, such as CaF₂, Fe₂O₃, CoO, CoTiO₃, Cr₂O3, Fe₂TiO. or SiO₂. They can be applied in accordance with or analogously to known methods, for example by cathodic sputtering, vapour-deposition or chemical vapour-deposition, or for certain layers by wet-chemical methods known therefor, which are described, for example, in WO 93/08237 and the further references given therein. General methods of vapour-deposition, cathodic sputtering or chemical vapour-deposition are best known to the person skilled in the art. It is advantageous to carry out such processes in vacuo, the pressure during the coating operation being from 10⁻¹ to 10⁻⁹ Pa. Metal oxides, with the exception of silicon oxides, are preferably vapour-deposited at a pressure of from 1.3·10⁻² to 1.3·10⁻³ Pa.

It will be understood that other coating methods known to the person skilled in the art can also be used. For example, coatings can be produced by sol/gel technology known from EP-A-0 504 926, JP-A-07/207186, JP-A-08/175823, JP-A-09/239311 and JP-A-10/204296, or silicon oxide coatings also from SiH₄ by thermal decomposition.

Silicon oxides are coated especially advantageously by vapour-deposition of metallic silicon in the presence of oxygen. For vapour-deposition, silicon (which need not necessarily be pure) is heated to a high temperature, for example to from 500° C. to 2000° C. by means of induction or electron-guns, in the presence of gaseous (molecular) oxygen (which also need not necessarily be pure) under reduced pressure in the vicinity of the substrate to be coated. Depending upon the relative molar concentration of the oxygen there are formed silicon suboxides having a greater or lesser degree of yellow to dark grey coloration or, preferably, colourless silicon dioxide.

It is especially possible to apply layers that are identical to or analogous to the insulating layers in re-writable optical recording media based on metal alloys (CD-RW), for example those comprising a mixture of SiO₂ and ZnS. As a result, development can be accelerated and further expenses for the coating process can be saved.

It can prove advantageous to treat the recording layer, before further coating, with an adhesion promoter, for example N-(3-(trimethoxysilyl)-propyl)pyrrole known from J. Amer. Chem. Soc. 104, 2031-4 (1982) and Chemistry of Materials 9/2, 399-402 (1997), titanium or zirconium salts, such as Ti(OiPr)₄ or Zr(acac)₄, and/or acids or bases, such as ammonia or primary, secondary or tertiary amines. Preference is given to the simultaneous use of an amine of formula 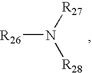
wherein R₂₆ is hydrogen or R₂₉; R₂₇ and R₂₈ are each independently of the other R₂₉, and R₂₉ is [−1,2-C₂-C₃alkylene-T-]ₙ-H, wherein T is O or NH and n is a number from 1 to 3, with an organometallic compound of the formula 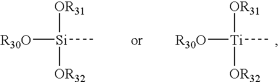
wherein R₃₀ to R₃₂ are C₁-C₄alkyl. In that case preferably the molar ratio of amine to organometallic compound is from 10:1 to 1000:1, the temperature from −20 to 150° C., especially from 20 to 80° C., and the treatment period from ¼ hour to 100 hours; more especially the molar ratio of amine to organometallic compound is from 50:1 to 250:1, the temperature from 50 to 80° C. and the treatment period from 1 to 10 hours.

If desired, such coatings can be applied, for example, in the same thickness also between the support material and the metallic reflector layer or between the metallic reflector layer and the optical recording layer. This may be advantageous in certain cases, for example when a silver reflector is used in combination with sulfur-containing additives in the recording layer.

Instead of, or in addition to, inorganic or cross-linked organometallic layers, it is also possible to use layers of a polymer which are applied, for example, by polymerisation, especially photopolymerisation, or by lamination.

It is especially advantageous for a covering layer having the thickness and optical properties disclosed above to be applied by polymerisation or lamination over the inorganic or cross-linked organometallic layer.

The invention therefore relates also to an optical recording medium comprising, in the following arrangement,
a) a support material of a reflecting metal or, preferably, of a polymer having a reflecting metallic layer;
b) an optical recording layer;
c) a separating layer of a metallic, cross-linked organometallic or dielectric inorganic substance; and
d) a covering layer.

The following Examples illustrate the invention in greater detail (unless specified differently, the UV/VIS spectra are measured in dichloromethane solution):

### EXAMPLE 1

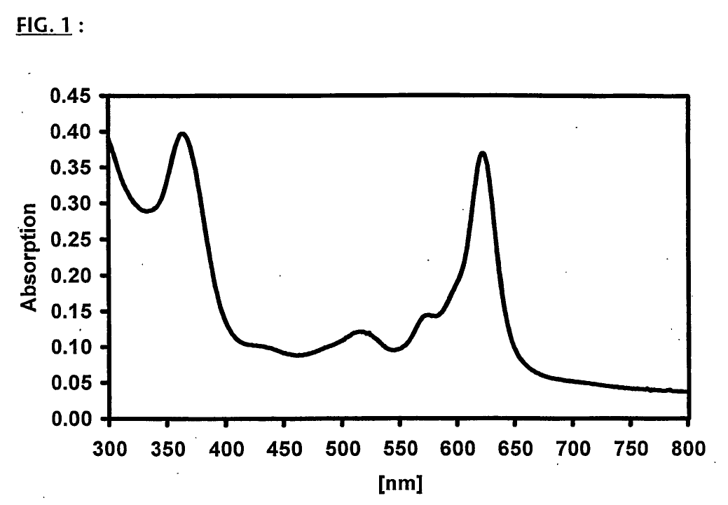

1.0% by weight of the product “(pyridine)₂Fe(OPTAP)” obtained in accordance with Transition Met. Chem. 14, 341-346 (1989) is dissolved in 99.0% by weight of a 85:15 mixture of 2-methoxyethanol and 2,6-dimethyl-4-heptanone, and the solution is filtered through a Teflon filter of pore size 0.2 μm and applied at 800 rev/min to the surface of a 0.6 mm thick, grooved polycarbonate disc (diameter 120 mm, groove depth 170 nm, groove width 350 nm, track spacing 0.74 μm). Excess solution is spun off by increasing the rotational speed. On evaporation of the solvent, the dye remains behind in the form of a uniform, amorphous solid layer. After drying in a circulating-air oven at 70° C. (10 min), the solid layer exhibits an absorption of 0.37 at 623 nm. The transmission spectrum of the solid is shown in FIG. 1.

A 70 nm thick layer of silver is applied to the resulting recording layer by atomisation in a vacuum coating, apparatus (Twister™, Balzers Unaxis). Then a 6 μm thick protective layer of a UV-curable photopolymer (650-020™, DSM) is applied thereto by means of spin-coating. The recording support exhibits a reflectivity of 48% at 658 nm. Using a commercial test apparatus (DVDT-R™, Expert Magnetics), marks are written into the active layer at a speed of 3.5 m/sec and a laser power of 9.5 mW using a laser diode of wavelength 658 nm. The dynamic parameters, which are determined on the same test apparatus, are very good: DTC jitter=9.5%; R14H=47%; I14/14H=0.55.

### EXAMPLE 2

A round-bottomed flask equipped with a magnetic stirrer, a reflux condenser, a thermometer a nitrogen inlet tube and a bubbler is charged with 23 g of diphenyl fumaronitrile and 46 ml of 1 -bromonaphthalene, and heated to 260-270° C. 9.8 g of neat liquid Fe(CO), are added to this solution dropwise from a funnel over 3 hours. The reaction is vigorously exothermic and produces a greenish-black solid which turns reddish-brown overnight. The reaction medium is then cooled to about 25° C. and 100 ml of n-hexane are added to the syrupy reddish-black solution. The resulting suspension is stirred for about 1 hour and then filtered. The resulting reddish black solid is extracted for 48 hours in a soxhlet with chloroform containing 10.9 g of cyclohexyl isocyanide. The resulting turquoise solution is evaporated to yield 14 g of as a purplish solid which shows a single spot in TLC (silica plate/toluene mobile phase). UV/VIS: λₘₐₓ=615 nm (ε=96000 l·mol⁻¹·cm⁻¹).

### EXAMPLE 3

Example 2 is repeated, but replacing cyclohexyl isocyanide by an equimolar amount of pyridine. UV/VIS: λₘₐₓ=617 nm (ε=98000 l·mol⁻¹·cm⁻¹).

### EXAMPLE 4

Example 2 is repeated, but replacing cyclohexyl isocyanide by an equimolar amount of methyl isocyanide.
UV/VIS: λₘₐₓ=614 nm (ε=76000 l·mol⁻¹·cm⁻¹).

### EXAMPLE 5

The compound of following formula is prepared in close analogy with the procedure of example 2: 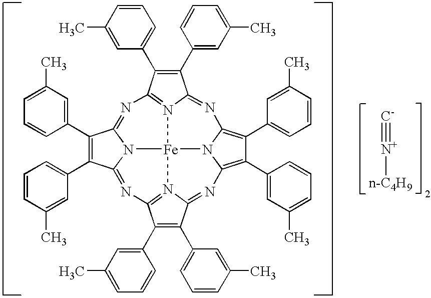 UV/VIS: λₘₐₓ=611 nm (ε=110000 l·mol⁻¹·cm⁻¹).

0.5% by weight of this product MZ42 is dissolved in dichloromethane and the solution is filtered through a Teflon® filter of pore size 0.2 μm and applied by spin-coating at 1000 r.p.m. to the surface of a 1.2 mm thick, flat glass disc of diameter 120 mm. The optical constants (absorption maximum λₘₐₓ, refractive index at 658 nm n₆₅₈, absorption coefficient at 658 nm k₆₅₈) are determined reflectometrically (ETA-RT™, ETA-Optik, Germany): λₘₐₓ=617 nm; n₆₅₈=1.92; k₆₅₈=0,092.

### EXAMPLE 6

The compound of following formula (only 1 of 4 isomers shown, the phenyl and tolyl groups on each pyrrole ring may be exchanged) is prepared in close analogy with the procedure of example 2: 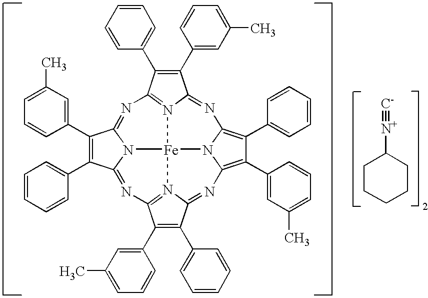 UV/VIS: λₘₐₓ=612 nm (ε=115000 l·mol⁻¹·cm⁻¹).

1% by weight of this product is dissolved in dichloromethane and the solution is filtered through a Teflon® filter of pore size 0.2 μm and applied by spin-coating at 1000 r.p.m. to the surface of a 1.2 mm thick, flat glass disc of diameter 120 mm. The optical constants (absorption maximum λₘₐₓ, refractive index at 658 nm n₆₅₈, absorption coefficient at 658 nm k₆₅₈) are determined reflectometrically (ETA-RT™, ETA-Optik, Germany): λₘₐₓ=621 nm; n₆₅₈=1.98; k₆₅₈=0,124.

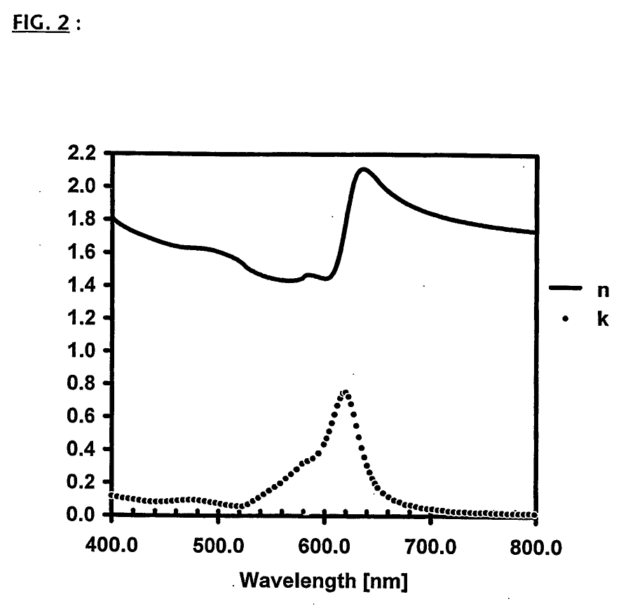

The complex refractive index of the solid at wavelength from 400 to 800 nm are shown in FIG. 2.

### EXAMPLE 7

The compound of following formula is prepared in close analogy with the procedure of example 2: 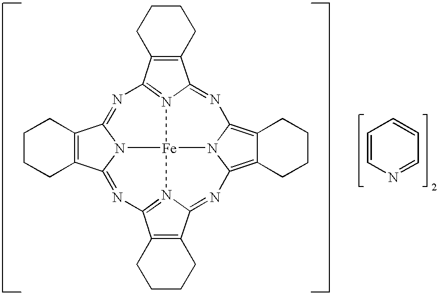 UV/VIS: λₘₐₓ=612 nm.

### EXAMPLE 8

The compound of following formula is prepared in close analogy with the procedure of example 2: 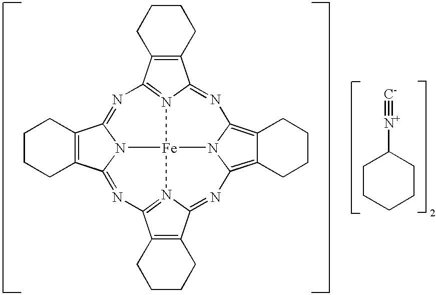 UV/VIS: λₘₐₓ=585 nm (ε=50000 l·mol⁻¹·cm⁻¹).

### EXAMPLE 9

The compound of following formula is prepared in close analogy with the procedure of example 2: 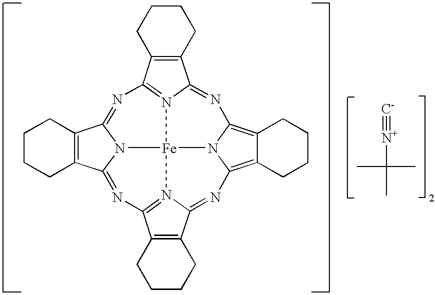 UV/VIS: λₘₐₓ=585 nm.

### EXAMPLE 10

The compound of following formula is prepared in close analogy with the procedure of example 2: 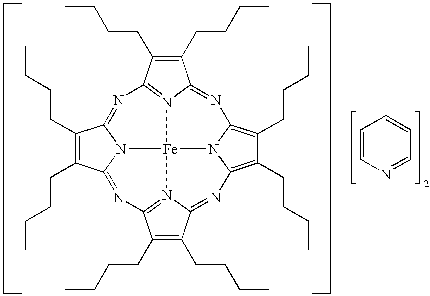 UV/VIS: λₘₐₓ=586 nm.

### EXAMPLE 11

The compound of following formula is prepared in close analogy with the procedure of example 2: 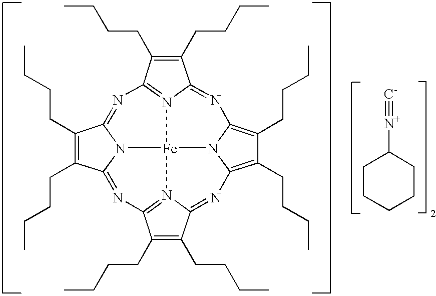 UV/VIS: λₘₐₓ=583 nm (ε=48000 l·mol⁻¹·cm⁻¹).

### EXAMPLE 12

The compound of following formula is prepared in close analogy to the procedure of example 2: 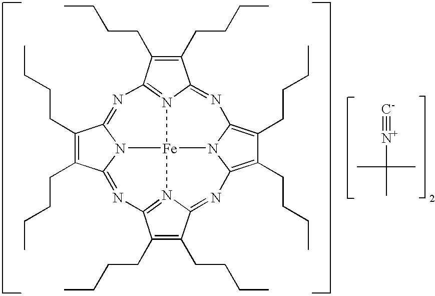
UV/VIS: λₘₐₓ=583 nm.

### EXAMPLES 13-23

Optical recording media are prepared according to the method of example 1, but replacing (pyridine)₂Fe(OPTAP) by the products of examples 2-12. Pits can be written and read out with excellent performance.

1. An optical recording medium comprising a substrate and a recording layer, wherein the recording layer comprises a complex of formula
$$\begin{matrix}\{ [ {Q}^{2} ] \cdot [ {M}^{m +} ] \cdot [ {L}_{1} ] \cdot {( [ {L}_{2} ] )}_{p} \} \frac{{X}_{2 - m}^{n}}{n} , & ( Ia ) \\ \{ [ {Q}^{2 -} ] \cdot [ {M}^{m +} ] \cdot [ {L}_{3} ] \cdot {( [ {L}_{2} ] )}_{q} \} \frac{{X}_{3 - m}^{n}}{n} & ( Ib ) \\ or \{ [ {Q}^{2 -} ] \cdot [ {M}^{m +} ] \cdot [ {L}_{3} ] \cdot [ {L}_{4} ] \} \frac{{X}_{4 - m}^{n}}{n} , & ( Ic )\end{matrix}$$
wherein
Q²⁻ is a ligand of formula 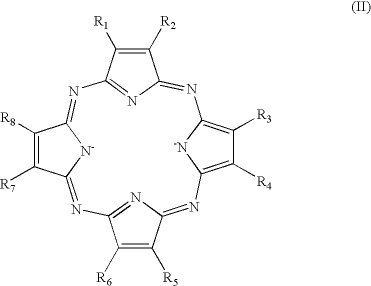
or a tautomer thereof,
and R₁, R₂, R₃, R₄, R₅, R₆, R₇ and R₈ are each independently of the others H, halogen, cyano, COOR₉, CONHR₉, CONR₉R₁₀, R₉, OR₉, SR₉, NHR₉ or NR₉R₁₀, wherein R₉ and R₁₀ are each independently of the other C₆-C₁₀aryl, C₄-C₉heteroaryl or linear or branched C₁-C₂₄alkyl, C₃-C₂₄cycloalkyl, C₂-C₂₄alkenyl, C₃-C₂₄cycloalkenyl, C₂-C₂₄alkynyl, Cl-Cl₂heterocycloalkyl, C₁-C₁₂heterocycloalkenyl, C₇-C₂₄aralkenyl or C₇-C₂₄aralkyl, each of which may be unsubstituted or substituted, it also being possible for R₁ and R₂, R₃ and R₄, R₅ and R₆, and R₇ and R₈, independently of one another, to be bonded by a direct bond or via a bridge O or S,
M^{m+} is a transition metal cation having 5 or 6 electrons in the outermost occupied d-shell,
L₁ is a ligand having a sub-structure N—C, P—C or As—C,
L₂, independently of L₁, is a further ligand containing at least one hetero atom N, P, As, O, S, Se or Te,
L₃⁻ is CN⁻, SCN⁻, NCS⁻, OCN⁻, NCO⁻, N₃⁻, L₁-O⁻, L₁-S⁻, L₁-CO₂⁻, L₁-SO₃⁻ or L₁-PO₃⁻, L₄⁻, independently of L₃⁻, is CN⁻, SCN⁻, NCS⁻, OCN⁻, NCO⁻, N₃⁻, L₃-O⁻, L₃-S⁻, L₃-CO₂⁻, L₃-SO₃⁻ or L₃-PO₃⁻,
p and q are each independently of the other a number 0 or 1,
$$\frac{{X}_{2 - m}^{n}}{n} , \frac{{X}_{3 - m}^{n}}{n} and \frac{{X}_{4 - m}^{n}}{n}$$
are each a counter-ion, m is a number 1, 2, 3 or 4 equal to the positive charge in M^{m+} and n is a number −2, −1, +1 or +2, so that the quotient
$$\frac{2 - m}{n} , \frac{3 - m}{n} or \frac{4 - m}{n}$$
is not negative.

2. A recording medium according to claim 1, wherein L₁ is selected from the group consisting of pyrrole, imidazole, pyrazole, pyridine, pyrazine, pyrimidine, pyridazine, indole, isoindole, indolizine, indazole, purine, quinolizine, quinoline, isoquinoline, 1,8-naphthyridine, phthalazine, quinoxaline, quinazoline, cinnoline, pteridine, carbazole, β-carboline, acridine, phenanthridine, per-imidine, 1,7-phenanthroline, phenazine, phenarsazine, phenothiazine, phenoxazine, oxazole, isoxazole, phosphindole, thiazole, isothiazole, furazan, pyrrolidine, piperidine, 2-pyrroline, 3-pyrroline, imidazolidine, 2-imidazoline, 4-imidazoline, pyrazolidine, 2-pyrazoline, 3-pyrazoline, piperidine, piperazine, indoline, isoindoline, quinuclidine, morpholine, 1,2,3-triazole, 1,2,4-triazole, benzotriazole, phosphinoline and phosphindoline, each of which may be unsubstituted or substituted by R₉, wherein R₉ is C₆-C₁₀aryl, C₄-C₉heteroaryl or linear or branched C₁-C₂₄alkyl, C₃-C₂₄cycloalkyl, C₂-C₂₄alkenyl, C₃-C₂₄cycloalkenyl, C₂-C₂₄alkynyl, C₁-C₁₂heterocycloalkyl, C₁-C₁₂heterocycloalkenyl, C₇-C₂₄aralkenyl or C₇-C₂₄aralkyl, each of which is unsubstituted or substituted by halogen, hydroxy, C₁-C₁₂alkyl, C₁-C₁₂alkoxy, C₁-C₈alkylthio, cyano, COOR₁₁ or by P(O)OR₁₁R₁₂, wherein R₁₁ and R₁₂ are each independently of the other linear or branched C₁-C₂₄alkyl, C₃-C₁₂cycloalkyl, C₇-C₂₄aralkyl, C₆-C₁₀aryl or C₄-C₉heteroaryl.

3. A recording medium according to claim 1, wherein L₁ is selected from the group consisting of nitriles, isonitriles, fulminates, cyanates, isocyanates, thiocyanates, isothiocyanates, azomethines, oximes, hydrazones, semicarbazones, imines, amidines and amidoximes.

4. A recording medium of formula
$$\{ [ {Q}^{2 -} ] \cdot [ {M}^{m +} ] \cdot [ {L}_{3} ] \cdot [ {L}_{4} ] \} \frac{{X}_{4 - m}^{n}}{n} \qquad ( Ic )$$
according to claim 1, wherein L₃⁻ and L₄⁻ are CN⁻, SCN⁻ or NCS⁻ and
$$\frac{{X}_{4 - m}^{n}}{n}$$
is a primary, secondary, tertiary or quaternary ammonium.

5. A recording medium according to claim 1, wherein M^{m+} is Fe²⁺ or Co³⁺.

6. A recording medium according to claim 5, wherein L₁ is an isonitrile of formula R₅—N⁺≡C⁻, wherein R₁₅ is unsubstituted or substituted, linear or branched C₁-C₂₄alkyl, C₃-C₁₂cycloalkyl, C₇-C₂₄aralkyl, C₆-C₁₀aryl or C₄-C₉heteroaryl.

7. A recording medium according to claim 1, comprising in addition a reflector layer and a covering layer, the substrate, reflector layer, recording layer and covering layer being arranged in that order.

8. A method of optically recording, storing and playing back information, wherein a recording medium according to claim 1, is used.

9. A method according to claim 8, wherein recording and playback are carried out in a wavelength range of from 350 to 500 nm or from 600 to 700 nm.

10. A method according to claim 9, wherein recording and playback are carried out in a wavelength range of from 600 to 700 nm.

11. A method according to claim 9, wherein recording and playback are carried out in a wavelength range of from 350 to 500 nm.

12. A method according to claim 9, wherein recording is carried out in a wavelength range of from 600 to 700 nm and playback is carried out in a wavelength range of from 350 to 500 nm.

13. A substance composition comprising a complex of formula
$$\begin{matrix}\{ [ {Q}^{2} ] \cdot [ {M}^{m +} ] \cdot [ {L}_{1} ] \cdot {( [ {L}_{2} ] )}_{p} \} \frac{{X}_{2 - m}^{n}}{n} , & ( Ia ) \\ \{ [ {Q}^{2 -} ] \cdot [ {M}^{m +} ] \cdot [ {L}_{3} ] \cdot {( [ {L}_{2} ] )}_{q} \} \frac{{X}_{3 - m}^{n}}{n} & ( Ib ) \\ or \{ [ {Q}^{2 -} ] \cdot [ {M}^{m +} ] \cdot [ {L}_{3} ] \cdot [ {L}_{4} ] \} \frac{{X}_{4 - m}^{n}}{n} , & ( Ic )\end{matrix}$$
according to claim 1 dissolved in an organic solvent selected from the group consisting of 2-methoxyethanol, n-propanol, isopropanol, isobutanol, n-butanol, amyl alcohol, 3-methyl-1-butanol, 2,2,2-trifluoroethanol, 2,2,3,3-tetrafluoro-1-propanol, dibutyl ether, 2,6-dimethyl-4-heptanone, 5-methyl-2-hexanone, toluene, xylene, 2,6-dimethyl-4-heptanone and mixtures thereof.

14. A method of producing an optical recording medium, wherein a substance composition according to claim 13 is applied by spin-coating to a substrate having one or more depressions.

15. (canceled).

16. A complex of formula
$$\begin{matrix}\{ [ {Q}^{2} ] \cdot [ {M}^{m +} ] \cdot [ {L}_{1} ] \cdot {( [ {L}_{2} ] )}_{p} \} \frac{{X}_{2 - m}^{n}}{n} , & ( Ia ) \\ \{ [ {Q}^{2 -} ] \cdot [ {M}^{m +} ] \cdot [ {L}_{3} ] \cdot {( [ {L}_{2} ] )}_{q} \} \frac{{X}_{3 - m}^{n}}{n} & ( Ib ) \\ or \{ [ {Q}^{2 -} ] \cdot [ {M}^{m +} ] \cdot [ {L}_{3} ] \cdot [ {L}_{4} ] \} \frac{{X}_{4 - m}^{n}}{n} , & ( Ic )\end{matrix}$$
wherein
Q²⁻ is a ligand of formula 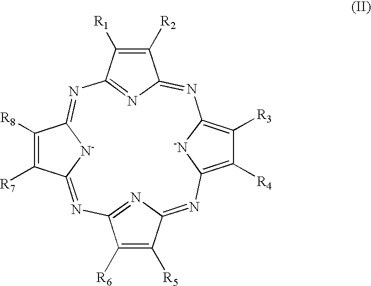
or a tautomer thereof,
and R₁, R₂, R₃, R₄, R₅, R₆, R₇ and R₈ are each independently of the others H, halogen, cyano, COOR₉, CONHR₉, CONR₉R₁₀, R₉, OR₉, SR₉, NHR₉ or NR₉R₁₀, wherein R₉ and R₁₀ are each independently of the other C₆-C₁₀aryl, C₄-C₉heteroaryl or linear or branched C₁-C₂₄alkyl, C₃-C₂₄cycloalkyl, C₂-C₂₄alkenyl, C₃-C₂₄cycloalkenyl, C₂-C₂₄alkynyl, C₁-C₁₂heterocycloalkyl, C₁-C₁₂heterocycloalkenyl, C₇-C₂₄aralkenyl or C₇-C₂₄aralkyl, each of which may be unsubstituted or substituted, it also being possible for R₁ and R₂, R₃ and R₄, R₅ and R₆, and R₇ and R₈, independently of one another, to be bonded by a direct bond or via a bridge O or S,
M^{m+} is a transition metal cation having 5 or 6 electrons in the outermost occupied d-shell, L₁ is a ligand having a sub-structure N—C, P—C or As—C,
L₂, independently of L₁, is a further ligand containing at least one hetero atom N, P, As, O, S, Se or Te,
L₃⁻ is CN⁻, SCN⁻, NCS⁻, OCN⁻, NCO⁻, N₃⁻, L₁-O⁻, L₁-S⁻, L₁-CO₂⁻, L₁-SO₃⁻ or L₁-PO₃⁻,
L₄⁻, independently of L₃⁻, is CN⁻, SCN⁻, NCS⁻, OCN⁻, NCO⁻, N₃⁻, L₃-O⁻, L₃-S⁻, L₃-CO₂⁻, L₃-SO₃⁻ or L₃-PO₃⁻,
p and q are each independently of the other a number 0 or 1,
$$\frac{{X}_{2 - m}^{n}}{n} , \frac{{X}_{3 - m}^{n}}{n} and \frac{{X}_{4 - m}^{n}}{n}$$
are each a counter-ion, m is a number 1, 2, 3 or 4 equal to the positive charge in M^{m+} and n is a number −2, −1, +1 or +2, so that the quotient
$$\frac{2 - m}{n} , \frac{3 - m}{n} or \frac{4 - m}{n}$$
is not negative, with the exception of those wherein p1 R₁, R₂, R₃, R₄, R₅, R₆, R₇ and R₈ are all phenyl, M is Fe(II), Ru(II) or Os(II) and L₁ and L₂ are both pyridine, or
R₁, R₂, R₃, R₄, R₅, R₆, R₇ and R₈ are all phenyl or p-tert-butyl-phenyl, M is Fe(II) and L₁ and L₂ are pyrazine, tert-butylisocyanide, cyclohexylisocyanide, phenylisocyanide or 2,3,5,6-tetramethyldiisocyanobenzene.

17. A substance composition comprising a compound of formula (Ia), (Ib) or (Ic) according to claim 1 and another chromophore which, in solid form, exhibits a maximum absorption (λₘₐₓ) in the range of from 350 to 620 nm, the ratio by weight of the compound of formula (Ia), (Ib) or (Ic) to the other chromophore being from 1:99 to 99:1.

18. A substance composition according to claim 17, wherein the other chromophore has the base structure [chemical structure]
